(19) United States
(12) Patent Application Publication
(10) Pub. No.: US 2024/0031439 A1
(43) Pub. Date: Jan. 25, 2024

(54) A CYBER-PHYSICAL SYSTEM FOR AN AUTONOMOUS OR SEMI-AUTONOMOUS VEHICLE

(71) Applicant: BeHaulT Industrial Property Office B.V., Genk (BE)

(72) Inventors: Philippe Arthur Jean Ghislain CHEVALIER, Deinze (BE); Geoffrey EJZENBERG, Berchem (BE); Noël JANS, Val-Meer(Riemst) (BE)

(21) Appl. No.: 18/265,162

(22) PCT Filed: Dec. 7, 2020
(86) PCT No.: PCT/EP2020/084946

§ 371 Date: Jun. 2, 2023

(51) Int. Cl. H04L 67/12; H04L 41/0663; B60W 60/00; B60R 16/03; B60W 50/06

(52) U.S. Cl. CPC H04L 67/12; H04L 41/0663; B60W 60/00; B60R 16/0315; B60W 50/06; B60W 2050/065

(57) ABSTRACT

A cyber-physical system for a vehicle capable of autonomous or semi-autonomous moving, wherein the cyber-physical system comprises a network with a plurality of units distributed therein, wherein the plurality of units includes sensors, actuators and vertices (e.g. embedded systems), wherein the plurality of units are distributed in the network in a fault tolerant wheel topology.

### CROSS-REFERENCE TO RELATED APPLICATIONS

The present application is the U.S. National Phase of PCT/EP2020/084946, filed on 7 Dec. 2020, the entire contents of which are incorporated herein by reference.

### TECHNICAL FIELD

The present invention relates to a cyber-physical system for a vehicle capable of autonomous or semi-autonomous moving. Further, the invention relates to a vehicle comprising a cyber-physical system. The invention also relates to a method of arranging a network of a cyber-physical system for a vehicle capable of autonomous or semi-autonomous moving. Additionally, the invention relates to a method for improving the key performance indicators of a vehicle using a cyber-physical system. Furthermore, the invention relates to a use of a cyber-physical system.

### BACKGROUND ART

Vehicles may include a cyber-physical system for enabling autonomous and/or semi-autonomous movement. A cyber-physical system (CPS) is a computer system in which a mechanism is controlled or monitored by computer-based algorithms. Such systems are well-known in the art and may include physical and software components which are intertwined, able to operate on different spatial and temporal scales, to exhibit multiple and distinct behavioral modalities, and to interact with each other in ways that change with context. The process control is often referred to as embedded systems. In embedded systems, the emphasis tends to be more on the computational elements, and less on an intense link between the computational and physical elements.

The term cyber-physical system (CPS), as given in the National Science Foundation document NSF19553, refers to engineered systems that are built from and/or depend upon, the seamless integration of computation and physical components. A CPS tightly integrates computing devices, actuation and control, networking infrastructure, and sensing of the physical world. The system may include human interaction with or without human aided control. A CPS may also include multiple integrated system components operating at a wide variety of spatial and temporal time scales. They can be characterized by architectures that may include distributed or centralized computing, multi-level hierarchical control and coordination of physical and organizational processes. CPS is a holistic approach to the design of machines.

Advances in CPSs should enable capability, adaptability, scalability, resilience, safety, security, and usability far beyond what is available in the simple embedded systems of today. CPS technology will transform the way people interact with engineered systems—just as the Internet has transformed the way people interact with information. CPSs are driving innovation and competition in a big range of sectors, such as: agriculture, aeronautics, building design, civil infrastructure, energy, environmental quality, healthcare and personalized medicine, manufacturing, and transportation. General principles in designing and developing system-on-chip (SoC) and multi-processor system-on-chip (MPSoC) can be found in the monographs of Bondavalli et al. and Marwedel. The design of the cyber-physical system of an autonomous or semi-autonomous mining dump truck follows the rules of the use of FPGAs in mission-critical systems as explained in the article of Adam Taylor. Autonomous self-configuration, as proposed in Patent 4, that could occur with components of a CPS should be constrained in the design of a CPS for autonomous or semi-autonomous mining dump trucks. This emergence property (see Bondavalli et al.) of the CPS or system-of-systems (SoS) should be confined such that the autonomous or semi-autonomous dump truck has a deterministic behavior. Patent 4 considers a CPS as having a central control unit generating component-independent request data which is also generated independently of the current operating state of the individual components. This approach of Patent 4 should not be followed for mission-critical systems (see Adam Taylor) as an autonomous or semiautonomous dump truck. The software layer of a cyber-physical system is best modelled using Unified Modelling Language (UML). The monographs of Eriksson, Hans-Erik and Penker Magnus and Fowler Martin are guidelines in using UML.

The advent of Internet-of-Things (IoT) allows CPS components to communicate with other devices through cloud-based infrastructure and to interact with (potentially) safety-critical systems, posing new research challenges in safety, security, and dependability. A guidebook for the cybersecurity for cyber-physical vehicle systems is issued by SAE International [SAE J3016-JAN2016].

The term hybrid electric refers to a vehicle that combines a conventional internal-combustion engine (ICE) or another engine with an electric propulsion system. The presence of the electric powertrain is intended to achieve either better fuel economy than a conventional vehicle and/or better performance.

There is a clear difference between the terminology used in the standard ISO 17757:2019 and the standard SAE J3016, that describes the six level-specific driving automation modes (level 0 to level 5). The SAE J3016 is mainly applicable for normal vehicles while ISO 17757:2019 is mainly applicable for off-highway machines and particularly for mining dump trucks.

The term ASAM, according to ISO 17757:2019, refers to both semi-autonomous machines operating in autonomous mode and autonomous machines.

The term autonomous mode, according to ISO 17757:2019, is defined as mode of operation in which a mobile machine performs all machine safety-critical and earth-moving or mining functions related to its defined operations without operator interaction. The operator could provide destination or navigation input but is not needed to assert control during the defined operation.

The term autonomous machine, according to ISO 17757:2019, refers to a mobile machine that is intended to operate in autonomous mode during its normal operating cycle.

The term semi-autonomous machine, according to ISO 17757:2019, refers to a mobile machine that is intended to operate in autonomous mode during part of its operating cycle and which requires active control by an operator to complete some of the tasks assigned to the machine.

It is a goal to provide for improved cyber-physical systems for vehicles. The vehicle may for instance be a dump truck for surface mining. Various models and types exist. Often, heavy-duty mining dump trucks are used in surface mining for hauling activities. These hauling activities comprise the movement of overburden and ore from a certain point in the mine to another point over well-defined routes. To optimize the hauling activities, it is considered by the mining industry to upgrade the existing dump trucks by installing add-on equipment allowing the existing trucks to become driverless. We will review this strategy used in the surface mining industry and propose an alternative that is the subject of this invention.

The standard heavy-duty mining dump trucks are found in the publications of Caterpillar, Hitachi, Komatsu, Liebherr and BelAz. An example of such a standard heavy-duty mining dump truck is given in Patent Document 1. A standard heavy-duty mining dump truck used in surface mines has generally a single unit frame equipped with two axles and six tires. The front axle is equipped with two steering, but non-driving wheels and the rear axle is equipped with four non-steering driving wheels as shown in Patent Document 2. Above the frame, in the front part, a cabin is mounted for the driver and in the rear part an open-end dump body is mounted.

It is known by the mining companies that any two-axle truck experience traction problems under adverse weather conditions because the slip torque of the wheels is function of the coefficient of friction of the soil. The torque of the dump truck is distributed over typically four driving wheels. It is therefore more likely that one or more driving wheels will have a torque larger than the slip torque and thus will lose traction bringing the mining dump truck in difficulties to execute its haulage mission.

In the worst scenario the truck will become uncontrollable resulting in damage to the equipment, loss of the payload and potential injuries to the driver and persons in the vicinity of the mining dump truck.

An uncontrollable mining dump truck blocking a road has an adverse effect on the throughput of the mining company. In many cases the haulage is put to a standstill until the mining dump truck is back in the maintenance bay. This clearly affects the availability of mining dump trucks. It is known that the typical availability of a standard mining dump truck is between 70% and 80%. An availability between 80% and 90% is considered by the mining industry as a major technical challenge, requiring a lot of innovation and inventivity of the dump truck designer.

Mining dump trucks with add-on sensor packs have proven to reduce load and hauling costs by more than 15% compared to the conventional haulage methods. Optimized automatic controls of the mining dump truck reduce sudden acceleration and abrupt steering, resulting in a 40% improvement in tire life compared to conventional operations.

Add-on sensor packs are mounted on existing conventional mining dump trucks. This add-on approach does not exploit at full the improvements that can be obtained using a cyber-physical design of a mining dump truck. A major drawback of the add-on sensor packs is the latency that occurs between the sensor and the actuator. The sensor and actuator are not in an optimum geometry with respect to each other resulting in an increase of the response time of the sensor-actuator system.

The add-on sensor packs are impediments to optimum operation of the mining dump trucks and these impediments are eliminated by the present invention.

### PRIOR ART DOCUMENTS

### Patent Publications

Patent Document 1: U.S. Pat. No. 7,604,300 (LIEBHERR MINING EQUIP) 20 Oct. 2009;
Patent Document 2: EP 1359032 A2 (LIEBHERR WERK BIBERACH) 5 Nov. 2003;
Patent Document 3: US 20180005118A1 (MICROSOFT TECHNOLOGY LICENSING) 30 Jun. 2016.
Patent Document 4: WO2016004973 A1 (SIEMENS AKTIENGESELLSCHAFT) 7 Jul. 2014;
Patent Document 5: U.S. Pat. No. 5,862,315 (THE DOW CHEMICAL COMPANY) 19 Jan. 1999.
Patent Document 6: EP3042703 A1 (OBSHCHESTVO S OGRANICHENNOY OTVETSTVENNOSTYU “KIBERNETICHESKIYE TEKHNOLOGII”) 13 Jul. 2016.

### Monograph Documents

Groves, Paul D., Principles of GNSS, INERTIAL, AND MULTISENSOR INTEGRATED NAVIGATION SYSTEMS, Artech House, ISBN 13:978-1-58053-255-6, 2008.
Bondavalli Andrea, Bouchenak Sara, Kopetz Hermann, Cyber-Physical Systems of Systems, Foundations—A Conceptual Model and Some Derivations: The AMADEOS Legacy, Lecture Notes in Computer Science 10099, Springer Open, ISBN 978-3-319-475890-5, 2016.
Marwedel Peter, Embedded System Design, Embedded Systems Foundations of Cyber-Physical Systems, and the Internet of Things, Third Edition, Springer, ISBN 978-3-319-56045-8.
Eriksson, Hans-Erik and Penker Magnus, UML Toolkit, ISBN 0471-191612.
Fowler Martin, UML Distilled, Third Edition, Addison-Wesley, 2004, ISBN 0-321-19368-7.
Parreira Julianna, An Interactive Simulation Model to Compare and Autonomous Haulage Truck System with a Manually-Operated System, PhD, The University Of British Columbia (Vancouver), 2013.
Schutte P C and Maldonado C C, Factors affecting driver alertness during the operation of haul trucks in the South African mining industry, CSIR Mining Technology, SIM 02 05 02 (EC03-0295), 2003.

### Article Document

NSF19553, Cyber-Physical Systems (CPS), National Science Foundation, Feb. 13, 2019.
R. E. Lyons and W. Vanderkulk, The use of Triple-Modular Redundancy to Improve Computer Reliability, IBM Journal, April 1962, pp 200-209.
A. P. Taylor, Using FPGAs in Mission-Critical Systems, Xcell Journal, Issue 73, 2010, pp 16-19.

### Standard Document

ISO 17757:2019, Earth-moving machinery and mining—Autonomous and semi-autonomous machine system safety, Second edition 2019-07.
SAE J3061-JAN2016, Cybersecurity Guidebook for Cyber-Physical Vehicle Systems, SAE International, Issued 2016-01.

### Problem to be Solved by the Invention

The problem to be solved is the improvement of the key performance indicators (KPIs) of vehicles. Various types of vehicles can be used. For example, the vehicle may be a dump truck. The invention may improve values of the key performance indicators of mining haulage, for example open surface mine haulage. Many mining companies consider the key performance indicator for a haulage vehicle as the overall yearly cost per metric ton. In doing so, lumped characteristics are considered showing a black-box approach like the rimpull curve of a mining dump truck. However, the metric based on yearly throughput per haulage route expressed in cost per metric ton is not the correct metric for comparing mining dump trucks in a future investment scenario to decarbonize the surface mining industry. This selection process, using our mathematical model of the dump truck, can be performed by comparing classical dump trucks with hybrid electric mining dump trucks or even full-electric mining dump trucks. Our mathematical model of the dump truck allows to design the most appropriate mining dump truck for the given route in the mine. As the mine layout changes over time one should be able to change the mining dump truck configuration to keep the highest values in the key performance indicators. The mathematical model of the dump truck is at the core of the cyber-physical system and is used by the cyber-physical system to control the mining dump truck in its physical space and cyberspace. The mathematical model of the dump truck shows that the availability of a dump truck has a large effect on the throughput of the overall mine.

It is also known that the actions of a driver of a dump truck is in many cases the origin of an accident in a surface mine [Schutte2003]. The driver is also at the basis of the variability of the throughput in the haulage process [Parreira2013]. It is evident that the mining industry wants to remove this risk factor. A common choice is to make the dump trucks driverless. Upgrade programs exist to transform the dump truck to autonomous or semi-autonomous dump trucks. To attain this goal, many companies choose to add field instruments on the original dump truck in the hope that this is sufficient to guarantee a safe autonomous or semi-autonomous operation of the dump trucks. Accidents have been reported between dump trucks that have received this type of upgrades. Some companies have argued that a paradigm change is needed to design autonomous and semi-autonomous dump trucks. A solution for the problem seems to be to design the mining dump truck from a cyber-physical system (CPS) perspective. However, challenges exist in controlling cyber-physical systems under uncertainty as discussed in Patent Document 3 where a probabilistic framework is developed that enables constraints to be defined for synthesis of control inputs of a cyber-physical system. In the invention disclosed in Patent Document 3 FIG. 1 the controller is primarily outside the cyber-physical system and processes the control inputs of the cyber-physical system. Patent Document 3 states that traditional approaches for synthesizing control inputs oftentimes do not consider uncertainty. We consider this above-mentioned problem as a lack in the experience of the control engineer who designs the cyber-physical system. Preferably, control systems are to be robust for disturbances. This robustness of the control system will result in an improved availability. A standard approach to improve the robustness is to uses triply redundant computers as in Patent Document 5. Patent Document 5 discloses a process control interface system having a network of distributed triply redundant input/output field computer units. Patent Document 5 states that even when triply redundant control is found to be desirable, a myriad of design problems must first be confronted in order to achieve a truly effective triply redundant control system, including the handling of internal failures within different areas of the triply redundant control system. However, the design problems arising in large scale chemical process control, as referred to in Patent Document 5, are different from those occurring in the autonomous and semi-autonomous hybrid mining dump trucks, especially in the dynamics of these control systems compared to those of an autonomous and semi-autonomous hybrid mining dump truck. Another difference with Patent Document 5 is the need to develop a method to identify locations on the dump truck where a triply redundant arrangement is economically most efficient. Patent Document 6 is related to the field of computer technology and automated control systems and claims to enable an increase in the quality and reliability of control in cyber-physical systems. The focus of the invention of Patent Document 6 is on the use of high computational complexity algorithms including adaptive adjustment algorithms, through CPU resources release and distribution of control functions among multiple computing subsystems. Patent Document 6 is not adequate for solving the haulage problems related to the availability of the mining dump truck that should be handled as a mission critical problem and thus should tackle redundancy issues leading to new hardware topologies for mining dump trucks.

The present invention, therefore, has as objective to disclose a cyber-physical system and a method of design of a cyber-physical system for improving the key performance indicators of a moving machine.

### SUMMARY OF THE INVENTION

It is an object of the invention to provide for a method and a system that obviates at least one of the above-mentioned drawbacks.

Additionally or alternatively, it is an object of the invention to improve the operation of the vehicle.

Additionally or alternatively, it is an object of the invention to improve the availability of the dump truck to the mining companies.

Additionally or alternatively, it is an object of the invention to improve the safety of operation of the vehicle.

Additionally or alternatively, it is an object of the invention to improve the reliability of the vehicle.

Additionally or alternatively, it is an object of the invention to improve the key performance indicators of the vehicle.

Thereto, the invention provides for a cyber-physical system for a vehicle capable of autonomous or semi-autonomous moving, wherein the cyber-physical system comprises a network with a plurality of units distributed therein, wherein the plurality of units includes sensors, actuators and embedded computational units, wherein the plurality of units are distributed in the network in a fault tolerant network topology.

Optionally, the fault tolerant network topology is a wheel topology formed by vertices which are interconnected by means of edges.

Optionally, the central vertex of the wheel network includes a central computing unit including at least three embedded systems. Each of the three embedded systems may be connected to the other embedded systems of the central computing unit. Instead of using a single embedded system in the central vertex, at least three embedded systems are employed, further improving the robustness. In case of three embedded systems, a triangular configuration may be employed. If one of the at least three embedded systems of the central computing unit fails or its connection with the other embedded systems fails, the cyber-physical system of the vehicle can continue its mission.

The central vertex (cf. central computing unit) in the wheel topology network may be considered as a sensitive core element of the cyber-physical system. Malfunctioning of the central vertex would compromise the operation of the cyber-physical system.

The points or locations at which a redundancy arrangement (e.g. triple modular redundancy) is provided can be determined by means of a fault mode analysis (FMECA). This fault/error mode analysis may allow the identification of critical components or paths within the network based on the selected allowed fault tolerance (e.g. single point failures, double point failures, triple point failures, etc.). Based on the result of the fault mode analysis, some selected vertices in the network are arranged in a redundancy arrangement (e.g. triple modular redundancy). The reliability of each of the components can be analyzed to determine a failure rate (e.g. mean time between failure or the like). From such results it can be monitored which components are sensitive in the moving machine and which are to be protected by applying a redundancy arrangement in order to reduce the failure rate of the moving machine.

The wheel topology may provide for a fault tolerant system. For a wheeled vehicle, it may be advantageous to arrange the redundancy arrangements at or adjacent physical or virtual axles of the vehicle. In some example, the redundancy arrangements are arranged at or adjacent wheels of the vehicle, e.g. at or adjacent each driven wheel of the vehicle. Although more complex, such configuration may further effectively increase the robustness of the system.

It will be appreciated that the invention can be employed in various types of vehicles. In some of the shown embodiments, a wheeled truck is illustrated. However, the vehicle may also be for example an unmanned aerial vehicle (UAV). Advantageously, by employing the method and system according to the invention, the UAV can initiate a safe landing or even continue operation if one of the engines fails, thereby reducing the risk of a crash. Similarly, the invention may also be employed for naval vehicles for example an unmanned surface vehicle (USV). The vehicle may also be a railway vehicle consisting of a series of connected vehicles for example a train.

In some examples, the vehicle is a multi-wheeled vehicle with an electric motor arranged at each driven wheel (e.g. four-wheeled vehicle with four electric motors at the wheels). A central computer may be arranged which enables electric control of the multiple motors. Instead of employing a star network topology (computer communicating with the different wheels), a wheel network topology is employed, wherein neighboring wheels are in communication with each other, preferably via a fibre-optic communication cable. In the example of a four-wheeled vehicle, a first wheel is connected to a second wheel via a cable; the second wheel is connected to a third wheel; the third wheel is connected to a fourth wheel; and all the wheels are also connected to a central vertex in order to form the wheel topology.

By applying a wheel topology, the redundancy/fault tolerance of a cyber-physical system of the vehicle can be improved. The entire network of the cyber-physical system may be mathematically represented as a graph of vertices (e.g. embedded systems) and edges (e.g. connection lines) forming a wheel topology. When the network topology is a graph in the form of a star then the graph becomes disjunct if an edge is removed between two vertices and thus the connection is lost. With a wheel topology, a connection between two points can be maintained, even if their direct connection is interrupted. The network can still operate normally while one or more connections are broken and/or interrupted. In this way, the control of critical functionalities can be better safeguarded.

The wheel network topology provides for an improved effective physical redundancy in the cyber-physical system of the vehicle. Each vertex in the wheel topology may be an embedded system (e.g. a computing unit, computer, system-on-a-chip (SoC), multi-processor system-on-a-chip (MPSoC), etc.). The vertices may be interconnected in such a configuration so that the wheel topology is formed. The vertices or embedded systems (SoCs/MPSoCs) may have a programmable logic part (PL) and a processing system part. Selected vertices or embedded systems may have in the programmable logic part (PL) their logic fabric in redundancy arrangement (e.g. triple modular redundancy).

By means of a fault mode analysis, weaknesses in the cyber-physical system of the vehicle may be identified. This may differ for different types of vehicles, such as wheeled vehicles (e.g. car, truck, etc.), aerial vehicles (e.g. unmanned aerial vehicles), naval vehicles (e.g. boats), etc. The vertices (e.g. embedded systems) with lower reliability in the wheel network can be identified and provided with a redundancy arrangement (e.g. triple modular redundancy in the embedded system).

At least one topology layer may be configured in a wheel network configuration. Optionally, a secondary wheel topology is set up per physical or virtual axle of wheeled vehicle. The secondary wheel topology can make the part of the network associated with each physical or virtual axle of the wheeled vehicle more robust. The physical or virtual axle of the vehicle may be more sensitive to faults and therefore require such secondary wheel topology.

Optionally, the network includes a plurality of topology layers, and wherein at least one topology layer of the plurality of topology layers of the network is arranged in a wheel topology arrangement.

In some examples, a plurality of vertices in the network may be set up in redundancy arrangements. The plurality of redundancy arrangements may be arranged in a wheel topology, with a central vertex (e.g. central embedded system or computer) arranged centrally and connected to each of the plurality of redundancy arrangements. The wheel topology may include many vertices (e.g. more than 50, more than 80, etc.).

Optionally, redundant subsets of vertices are arranged in a redundancy arrangement in the network, and wherein non-redundant subsets of vertices are arranged in a non-redundancy arrangement in the network.

Optionally, the redundancy arrangement includes at least one of a triple modular redundancy arrangement, a four modular redundancy arrangement or a five modular redundancy arrangement.

Optionally, the network has a primary wheel topology arrangement and a secondary wheel topology arrangement, wherein the redundant subsets are connected in the primary wheel topology arrangement, and wherein the non-redundant subsets are connected in the secondary wheel topology arrangement.

Optionally, the edges are fiber-optic communication lines configured to convey at least three electromagnetic signals with different wavelengths.

Optionally, the network includes a central vertex arranged at the center of the wheel, wherein the central vertex is a central computing unit comprising at least three embedded computational systems communicatively coupled with respect to each other.

Optionally, the central computing unit comprises at least a first, second, and third embedded computation system, wherein the first embedded computational system of the central computing unit is configured to receive and process first electromagnetic signals with a first wavelength from the plurality of embedded systems of the wheel network which are arranged around the central computing unit, wherein the second embedded computational system of the central computing unit is configured to receive and process second electromagnetic signals with a second wavelength from the plurality of embedded systems of the wheel network which are around the central computing unit, and wherein the third embedded computational system of the central computing unit is configured to receive and process third electromagnetic signals with a third wavelength from the plurality of embedded systems of the wheel network which are around the central computing unit.

Optionally, the vertices arranged around the central vertex are embedded computational systems each including a programmable logic part, wherein the programmable logic part (PL) comprises at least three distinct logic fabrics each dedicated to concurrently process the information carried by one of the at least three electromagnetic signals with different wavelengths.

Optionally, each of the embedded systems of the central computing unit is configured to receive processing results from the other embedded systems of the central computing unit.

Optionally, the central vertex comprises a central validator, wherein each of the embedded systems of the central computing unit is configured to transmit its processing results to the validator, wherein the validator is configured to check whether the at least three embedded system of the central computing unit generate the same processing results.

Optionally, the network includes a plurality of multiplexers arranged at at least a subset of the embedded computational systems arranged in redundancy arrangement, wherein validators of the subset of the embedded computational systems are arranged at or integrated with the multiplexers.

Optionally, the redundant subsets are allocated to preselected critical units of the vehicle.

Optionally, the vehicle is a wheeled vehicle, and wherein the redundant subsets are allocated to at least one of each wheel of the vehicle or each physical or virtual axle of the vehicle.

Optionally, the secondary wheel topology arrangement is arranged at the wheels of the wheeled vehicle.

Optionally, the secondary wheel topology arrangement is arranged at the physical or virtual axles of the vehicle.

Optionally, the vehicle includes at least two physical or virtual axles, wherein each of the at least two physical or virtual axles of the vehicle is provided with a subset of vertices configured in a redundancy arrangement, wherein each subset of vertices includes at least three vertices, wherein each vertex of a same subset of vertices is configured to produce an output indicative of a same event independently from other vertices of the same subset of vertices, and wherein each subset of vertices is communicatively coupled to a validator unit configured to monitor and compare the output of the vertices of the same subset of vertices in order to determine whether each of the outputs indicates occurrence of the same event, wherein the validator unit is configured to identify a failing vertex responsive to determining that the failing vertex does not indicate the occurrence of the same event as the outputs of the other vertices of the same subset of vertices that do indicate the occurrence of the same event, and wherein the cyber-physical system is configured to continue operation using the outputs of the other vertices of the same subset of vertices and without using the different output generated by the failing vertex of the same subset of vertices.

Optionally, the graph of the cyber-physical system includes a first subset of vertices in redundancy arrangement and a second subset of vertices in redundancy arrangement, wherein the vertices of the first subset of vertices and the vertices of the second subset of vertices are dedicated to a first physical or virtual axle of the vehicle and a second physical or virtual axle of the vehicle, respectively, and wherein the vertices of the first subset of vertices are positioned at or adjacent to the first physical or virtual axle, and wherein the vertices of the second subset of vertices are positioned at or adjacent to the second physical or virtual axle.

Optionally, the graph of the cyber-physical system includes at least one further subset of vertices in redundancy arrangement and dedicated to a further physical or virtual axle of the vehicle, wherein the vertices of the at least one further subset of vertices are positioned at or adjacent to the further physical or virtual axle of the vehicle.

Optionally, each physical or virtual axle of the vehicle is provided with at least one dedicated subset of vertices in redundancy arrangement.

Optionally, each validator unit includes a voter-comparator integrated circuit coupled to the at least three vertices of the respective subset of vertices, the voter-comparator circuit configured to validate redundant data outputs of the at least three vertices in the respective subset of vertices, wherein the voter-comparator circuit is configured to determine an output result according to a majority of the plurality of redundant outputs of each of the at least three-vertices in the respective subset of vertices.

Optionally, the voter-comparator integrated circuit is configured to detect a computation error or faulty output according to the plurality of redundant outputs generated by the at least three vertices in the respective subset of vertices.

Optionally, the vertices (e.g. embedded systems) in redundancy arrangement execute a same application software in a separated and isolated memory segments and in one or more dedicated processors.

Optionally, the vertices (e.g. embedded systems) in redundancy arrangement execute similar sets of instructions in separated logic fabrics of the programmable logic part of the embedded system. Optionally, the cyber-physical system includes a synchronization unit configured as resilient master clock to synchronize data streams from the plurality of vertices (e.g. embedded systems) in redundancy arrangement.

Optionally, each redundant subset of vertices (e.g. embedded systems) is arranged in a triple modular redundant configuration.

Optionally, the validator unit has a higher mean time to failure than the vertices (e.g. embedded systems).

Optionally, the subsets of vertices (e.g. embedded systems) are arranged in a secure wired network or secure fiber-optic network of the cyber-physical system.

Optionally, the subsets of vertices (e.g. embedded systems) are arranged in a secure wireless network of the cyber-physical system.

Optionally, each vertex (e.g. embedded system) in redundancy arrangement is equally distanced with respect to the validator unit.

Optionally, the cyber-physical system includes a decentralized network, having a planar or non-planar graph topology composed of sub-graphs having particularly a wheel topology of vertices and edges.

Optionally, each vertex is composed of a subset of System-on-Chip or multiple processor System-on-Chip (MPSoC) mounted on dedicated high reliability carrier boards.

Optionally, a set of sensors distributed in the network of the vehicle are comprising: a situational awareness system; a meteorological mast unit that measures for example air temperature, relative humidity, air pressure, wind direction and wind velocity; a set of wheel measurement units that measure for example the travelled distance, the angular velocity of a wheel, the angular acceleration of a wheel; a set of temperature sensing units that measure for example the contact temperature at critical points of the vehicle assemblies, the fluid temperatures in the hydraulic system, the temperatures in the pneumatic system, the temperatures in the cooling system, the temperatures in the electrical system; a set of pressure sensing units that measure for example hydraulic pressures in the hydraulic system, pneumatic pressures in the pneumatic system; a set of flow sensing units that measure for example the fluid flow in the hydraulic system, the gas flow in the pneumatic system; a set of inertial measurement units that measure for the sprung mass of the vehicle and for the unsprung mass locations on the vehicle for example the yaw rate, the roll rate, the pitch rate, the longitudinal acceleration, the lateral acceleration, the vertical acceleration; a set of attitude units that measure for example the position of the vehicle with respect to global coordinates, the inclination with respect to an inertial plane; a set of energy storage management systems that measure for example the voltage of the energy storage system, the current of the energy storage system, the temperature of the energy storage system; a set of vehicle housekeeping systems that measure for example the fuel level, the oil level, the oil temperature, the tire pressure, the spray liquid level, the auxiliary battery status.

Optionally, the situational awareness system that is configured to generate an imaging dataset for processing by the cyber-physical system for enabling semi-autonomous or autonomous operational mode of the vehicle is comprising: a long range electro-optical unit that identifies for example persons at long range; a short range electro-optical unit that identifies for example persons at short range; a ground looking electro-optical unit that identifies for example objects in the very close proximity of the vehicle; a radar unit that measures for example objects in the front and the back of the vehicle; a data synchronization unit configured to synchronize the imaging dataset obtained by means of each imaging and ranging unit, wherein the data synchronization system is configured to provide the synchronized imaging dataset to the fault-tolerant cyber-physical system of the vehicle and that presents a spatial and temporal consolidated dataset to the fault-tolerant cyber-physical system.

Optionally, a set of actuators distributed in the network of the vehicle are connected to control systems comprising: a vehicle handling control module comprising: a driving control module that adjust torque applied by an electric motor to a wheel; a suspension control module that adjust the vertical position and inclination of wheels; a steering control module that adjust the yaw of the wheels.

Optionally, the network of the vehicle is connected externally with a supervisor control unit (SCU) through a secure wireless communication system with internet-of-things (IoT) capabilities.

According to an aspect, the invention provides for a vehicle comprising a cyber-physical system according to the invention. Optionally, the vehicle is a naval vessel for example an unmanned surface vehicle (USV). Optionally, the vehicle is a flying vehicle for example an unmanned aerial vehicle (UAV).

Optionally, the vehicle is a dump truck, an off-highway dump truck, an autonomous or semi-autonomous dump truck, an electric dump truck, a hybrid electric dump truck or an off-highway autonomous or semi-autonomous hybrid electric dump truck.

According to an aspect, the invention provides for a method of arranging a network of a cyber-physical system for a vehicle capable of autonomous or semi-autonomous moving, the method comprising the steps of receiving an initial network design with a plurality of interconnected distributed units, wherein the plurality of units includes sensors, actuators, and vertices (e.g. embedded systems); performing a fault analysis to identify lower reliability items in the initial network design with a reliability lower than a threshold value; arranging the lower reliability items in redundancy arrangements; interconnecting the redundancy arrangements in a fault tolerant network topology.

Optionally, the fault tolerant network topology has a wheel topology.

Optionally, the redundancy arrangement is at least one of a triple modular redundancy arrangement, a four modular redundancy arrangement or a five modular redundancy arrangement.

According to an aspect, the invention provides for a method for improving the key performance indicators of a vehicle using a cyber-physical system, the method comprising the steps of interpolate the nominal state vector of the cyber-physical system from pre-calculated states derived from the digital twin of the vehicle by parameter tuning of meteorological data, terrain data, safety data and vehicle dynamics data; calculate the actual state vector of the cyber-physical system derived from the digital twin of the vehicle by measuring of meteorological data, terrain data, safety data and vehicle dynamics data; compare the actual state vector and the nominal state vector of the cyber-physical system of the vehicle; determine the corrective actions to let the actual state vector coincide with the nominal state vector of the cyber-physical system of the vehicle; execute the proposed corrective actions; verify the equality of the actual state vector and the nominal state vector of the cyber-physical system of the vehicle after the corrective actions.

According to an aspect, the invention provides for a dump truck for surface mining, comprising: at least two physical or virtual axles with wheels associated therewith; a cyber-physical system connected to a situational awareness system, that is configured to generate an imaging dataset for processing by the cyber-physical system for enabling semi-autonomous or autonomous operational mode of the dump truck, wherein the situational awareness system includes a sensory system with a first electro-optical unit, a lower deck unit, a second electro-optical unit configured for imaging a ground area in a direct vicinity of the dump truck, a dump body inspection unit, a radar unit, and a third electro-optical unit, wherein the situational awareness system further includes a data synchronization system configured to synchronize the imaging dataset obtained by means of each unit of the sensory system, wherein the data synchronization system is configured to provide the synchronized imaging dataset to the cyber-physical system of the dump truck; a cyber-physical system including a control system, which is configured to use the sensory data for autonomous or semi-autonomous driving of the dump truck, and that optimizes the key performance indicators, being at least the overall availability of the dump truck, the dump truck handling, the dump truck navigation, the energy management of the dump truck, the safety of the dump truck, the hybrid electric operation of the dump truck and the throughput of the dump truck; a cyber-physical system including a plurality of processing units at different locations of the dump truck, forming a bi-directional distributed network of processing units that is robust against single point failures of the network connectivity and/or processing unit failures; a cyber-physical system wherein each of the at least two physical or virtual axles of the dump truck is provided with a set of processing units configured in a redundancy arrangement, wherein each set includes at least three processing units, wherein each processing unit of a same set is configured to produce an output indicative of a same event independently from other processing units of the same set, and wherein each set is communicatively coupled to a validator unit configured to monitor and compare the output of the processing units of the same set in order to determine whether each of the outputs indicates occurrence of the same event, wherein the validator unit is configured to identify a failing processing unit responsive to determining that the failing processing unit does not indicate the occurrence of the same event as the outputs of the other processing units of the same set that do indicate the occurrence of the same event, and wherein the cyber-physical system is configured to continue operation using the outputs of the other processing units of the same set and without using the different output generated by the failing processing unit of the same set.

The dump truck with the cyber-physical system using strategically located processing units in redundancy arrangement at the physical or virtual axles provides increased robustness for disturbances. The reliability of the cyber-physical system can be significantly increased with limited additional redundant hardware components in the dump truck resulting in a higher dump truck availability. The cyber-physical system includes a synchronization unit configured as a resilient master clock to synchronize data processing by the plurality of processing units in redundancy arrangement.

Advantageously, in some examples, the redundancy arrangements of the cyber-physical system are configured at physical or virtual axle level of the dump truck. All data related to a single physical or virtual axle can be passed to a set of processing units in redundancy arrangement, for example running the mathematical model of the dump truck for the relevant physical or virtual axle. This can be done for each physical or virtual axle of the dump truck.

It is often too costly to arrange redundant hardware components at many locations of the cyber-physical system. The invention solves this problem by strategically positioning processing units in redundancy arrangement, at positions linked to the physical or virtual axles of the dump truck such as to maximize the availability of the dump truck. The data can be consolidated at the physical or virtual axles of the dump truck, wherein at the consolidation points the redundancy is increased by applying for instance a triple modular redundancy arrangement.

The cyber-physical system may be implemented by means of a hardware layer and a software layer which are configured to closely interact with each other. The hardware layer may be particularly designed based on typical properties of a dump truck, providing a wide range of important advantages. The cyber-physical system of the dump truck includes redundancy features for ensuring high reliability. This redundancy can be achieved in the hardware network topology by means of multiple modular redundancy arrangements. For instance, a triple modular redundancy arrangement may be employed. However, other redundant configurations of processing units are also envisaged. In this way, it can be effectively ensured that when one of the important hardware components fails, the cyber-physical system can remain operational. Some mission-critical hardware components are replaced by a multiple modular redundancy arrangement (e.g. divided into three parts, and at least one voter for determining a more reliable output).

Optionally, the cyber-physical system includes a first set of processing units in redundancy arrangement and a second set of processing units in redundancy arrangement, wherein the processing units of the first and the processing units of the second set are dedicated to a first physical or virtual axle of the dump truck and a second physical or virtual axle of the dump truck, respectively, and wherein the processing units of the first set are positioned at or adjacent to the first physical or virtual axle, and wherein the processing units of the second set are positioned at or adjacent to the second physical or virtual axle.

The redundancy arrangement can be provided for processing units dedicated to individual physical or virtual axles. By providing such redundancy on the physical or virtual axle-level, the reliability of the cyber-physical system can be significantly increased. Assuming that this redundancy arrangement would not be present then it is obvious that a failure at a level of a physical or virtual axle could bring the dump truck to a stand-still, resulting in a reduction and even in some cases to a halt of the mine throughput. Often, the dump truck collects and processes data at a physical or virtual axle level, for instance about the electric motor drive train, the individual battery management systems, the orientation of the wheels with respect to the inertial plane of the truck, for providing control for autonomous and/or semi-autonomous driving of the dump truck. The vulnerable locations in the network topology may thus be located at the physical or virtual axle-level. The invention exploits this by providing a multiple modular redundancy arrangement at a physical or virtual axle-level of the dump truck (e.g. for each individual physical or virtual axle of the dump truck).

Optionally, the cyber-physical system includes at least one further set of processing units in redundancy arrangement and dedicated to a further physical or virtual axle of the dump truck, wherein the processing units of the at least one further set are positioned at or adjacent to the further physical or virtual axle of the dump truck.

The dump truck may include a plurality of further sets of processing units in redundancy arrangement and dedicated to a plurality of respective further physical or virtual axles of the dump truck. By providing the redundancy arrangement at the physical or virtual axle-level of the dump truck, the robustness of the cyber-physical system of the dump truck can be effectively improved resulting in a higher availability of the dump truck.

Optionally, each physical or virtual axle of the dump truck is provided with at least one dedicated set of processing units in redundancy arrangement.

The dump truck can be considered as a system-of-systems, with a large variety of subsystems. According to the current invention, the multiple modular redundancy arrangement of the cyber-physical system is provided at various advantageous locations. These locations may be discovered by creating a graph using standard graph theory and calculating the degree of each vertex in the graph. Functional bottlenecks of the dump truck are those vertices where the degree is maximum. Sorting the vertices as function of their degree from high degree to low degree gives a ranking to the vertices. Economical and safety considerations will finally be at the basis of the selection of the vertices promoted to require a redundant arrangement.

The detailed calculations need also to consider the weight function applied to the edges connecting the vertices of the dump truck distributed network topology. The dump truck can be a multi-axle truck with multiple physical or virtual axles. By providing a multiple (e.g. triple) modular redundancy for each physical or virtual axle, the reliability of the cyber-physical system can be enhanced significantly and thus the overall availability of the truck to the mine.

Optionally, each validator unit includes a voter-comparator integrated circuit coupled to the at least three processing units of the respective set, the voter-comparator circuit configured to validate redundant data outputs of the at least three processing units in the respective set, wherein the voter-comparator circuit is configured to determine an output result according to a majority of the plurality of redundant outputs of each of the at least three-processing units in the respective set.

Optionally, the validator unit or voting unit is not a computer. The voting unit may for instance be a logical circuit (having a significantly higher reliability than processing units such as computers, field programmable gate arrays, system-on-chip . . . ). The voting unit can be configured to receive multiple input signals which in normal operation would be equal within a given tolerance as these signals are results of the same computation performed on different processing units. Based on the plurality of outputs of the processing units arranged in modular redundancy arrangement, the voting unit can generate one output signal which is more reliable than the outputs of the individual processing units communicatively coupled to the voting unit.

Optionally, the voter-comparator integrated circuit is configured to detect a computation error or faulty output according to the plurality of redundant outputs generated by the at least three processing units in the respective set.

The voting unit (also called validator unit) can be based on electronic components with a very high reliability having a significantly higher mean time to failure (MTTF) especially compared to one or more processing units of the cyber-physical system. In some examples, the voting unit is a chip or integrated circuit for example including AND-functionality. For example, the voting unit may be free of a processor (e.g. CPU, FPGA, ASIC, or the like). The voting unit may be arranged as an electronic circuit with a high reliability and/or durability compared to other components of the cyber-physical system, such as the processing units. The voting unit may be an electronic circuit arranged on a ruggedized printed circuit boards (PCB).

The three signals from the at least three processing units arranged in redundancy are then provided as input to the voting unit (cf. validator unit), based on which an output is generated (e.g. temperature of sensor, navigation of truck at certain positions, control parameters, et cetera.). The three processing units can be considered as the modules of the voting unit. In case of exactly three processing units, the arrangement can be considered as a triple modular redundancy (TMR) configuration. The processing units in redundancy arrangement execute application software, that was developed by three different software teams but with the same functionality goals, in separated and isolated memory segments and in one or more dedicated processors, that have been selected from different production batches.

In some examples, the cyber-physical system of the dump truck obtains information about the state of the dump truck by receiving sensor data from a plurality of sensors. The sensor data can be provided as input parameters to the mathematical model of the dump truck. Control signals for the actuators may be generated by means of the mathematical model of the dump truck. For example, some sensors may be configured to measure positions and/or orientations of the dump truck. The mathematical model of the dump truck can, based on at least the sensor data measured by these sensors, adjust control signals for enabling autonomous or semi-autonomous driving of the dump truck.

The mathematical model of the dump truck may be implemented as software or firmware on the processing units. For instance, the at least three processing units can be configured to run the same mathematical model software of the dump truck (redundancy). In some examples, each processing unit is a system-on-chip (SoC) communicatively connected to a voting unit, which can be an integrated circuit configured to generate an output based on a majority of the outputs generated by the at least three processing units. In an ideal situation, each processing unit generates a same output, and this output is further propagated in the cyber-physical system. However, if one of the outputs of the processing units is not equal within a predetermined tolerance to the outputs of the at least two other processing units, the output forwarded by the voting unit corresponds to the output obtained by a majority voting. In the case that all the outputs of the processing units are different, taking in account the tolerances, then the vertex of the network will be labelled defective and the information request or data stream will be rerouted using the wheel topology of the distributed network of processing units.

In some examples, for each set of processing units arranged in a redundancy arrangement (e.g. three processing units arranged in a triple modular redundancy arrangement), a voting circuit (cf. validator unit) can be arranged for performing the majority voting on the outputs generated by each processing unit of the set. Advantageously, the redundancy arrangements of the cyber-physical system can be set up at central locations at the physical or virtual axles. It can be advantageous to position the one or more processing units, that enable execution of the mathematical model of the dump truck, at or near the physical or virtual axles, as most data is collected there. Optionally, the processing units that are arranged to execute the mathematical model of the dump truck are positioned in a redundancy arrangement. The cyber-physical system may have other processing units with other functions than running the mathematical model of the dump truck, such as for example functions related to data reduction of an image, situational awareness, energy management of battery, et cetera. Optionally, multiple of these functions can be integrated into one processing unit of the CPS.

Optionally, each set is a triple modular redundant set. The triple modular redundant set may include at least three processing units in communication with a validator unit or voting unit for determining a voted output based on majority voting of the outputs of the individual at least three processing units. In some examples, the triple modular redundant set has exactly three processing units arranged in redundancy mode.

The invention can provide for an improved hardware distribution of processing units of the cyber-physical system over the dump truck. The processing units of the cyber-physical system may house at least parts of the control system. In the above examples, a triple modular redundancy architecture is provided for improving the reliability of the dump truck. The triple modular redundancy can be obtained by a set of at least three processing units (e.g. computers, field programmable gate array, System-on-Chip . . . ) which are configured to execute application software, that was developed by three different software teams but with the same functionality goals, in separated and isolated memory segments and in one or more dedicated processors, that have been selected from different production batches, such that all three software applications should return an output (e.g. Xa, Xb, and Xc) which is to be equal (e.g. Xa=Xb=Xc) within given tolerances. The voter-comparator integrated circuit (cf. voting unit or voting circuit) can be arranged outside the three processing units (e.g. separate high mean time to failure electronic unit). The voting unit can be configured to receive the outputs of the three processing units as an input and determines whether they are the same (logic circuit, voting circuit). For example, if one output of the three outputs of the three processing units is different, then this result can be discarded and the output of the remaining two processing units (equal) can be considered as the true output. Then, the processing unit providing the faulty output can be flagged as potentially damaged and/or malfunctioning. The processing unit can be repaired or replaced for example during maintenance of the dump truck. In this way, the dump truck can remain operational while one of the hardware components (cf. processing units) is failing. As most data is collected at the physical or virtual axles of the dump truck, it can provide significant advantages to arrange the redundant architecture at the physical or virtual axles.

Optionally, the validator unit has a higher mean time between failure (MTTF) than the processing units.

It may be ensured that the validator unit is expected to have a higher durability and/or reliability than the processing units. If one of the multiple processing units arranged in multiple redundant modular arrangement fails, an alarm may be triggered, and this component may then subsequently be replaced.

Optionally, the sets of processing units are arranged in a wired network or fiber-optic network of the cyber-physical system.

Optionally, each processing unit in redundancy arrangement is equally distanced with respect to the validator unit. In this way, an improved synchronization can be obtained regarding the outputs of the processing units which are arranged in redundancy arrangement.

Optionally, the cyber-physical system includes a bi-directional decentralized network, composed of sub-graphs having preferentially a wheel topology of computing units. The wheel topology has the advantage of being robust against the occurrence of single point failures in the bi-directional decentralized network.

The bi-directional decentralized network takes a non-planar graph topology for dump trucks equipped with at least three physical or virtual axles.

Optionally, a plurality of processing units is composed of a set of System-on-Chip (SoC) or multiple processors system-on-chip (MPSoC), e.g. mounted on dedicated high reliability carrier printed circuit boards (PCB). In some examples, each of the processing units is composed of a set of SOCs or MPSoCs.

Transmission time of the multiple vertices to central computer in the wheel topology network can be made substantially equal, which can result in time synchronous operation. For example, the shortest path to the central vertex may have a same length, Furthermore, secondary paths between the vertices may also have a same length. In this way, time synchronization can be effectively achieved by the geometric arrangement of the vertices and the edges in the network. By using same primary and secondary cable length paths, synchronized transmission can be achieved via direct and non-direct communication paths within the wheel network.

In some examples, visual data from a situational awareness system (SAS) of the dump truck (for instance including a plurality of sensors) is provided to the mathematical model of the dump truck for processing. The mathematical model of the dump truck can be executed on one or more processing units (e.g. SOC1, SOC2, SOC3) of the cyber-physical system of the dump truck. For instance, consolidated data can be time synchronized and transmitted from a data synchronization unit (DSU) to a plurality of processing units of the cyber-physical system (e.g. SOC1, SOC2, SOC3), e.g. via a wired network connection or fiber-optic network connection.

Optionally, the cyber-physical system further includes one or more software implemented techniques for increasing the reliability (e.g. measures to prevent and correct single event upset (SEU)). The combination of such software techniques with the implemented hardware redundancy arrangements can further increase the reliability of the cyber-physical system of the dump truck and improve the overall availability of the dump truck to the mining haulage process.

According to an aspect, the invention provides for a method of arranging a cyber-physical system of a surface mining dump truck with at least two physical or virtual axles, the cyber-physical system enabling continued safe operation with failed components, the method including: providing the cyber-physical system with a sensing system and a control system, wherein the sensing system comprises a plurality of sensors for providing sensory data to the control system which is configured to use the sensory data for enabling autonomous or semi-autonomous driving of the dump truck; providing the cyber-physical system with a plurality of processing units distributed at different locations of the dump truck;
providing each of the at least two physical or virtual axles of the dump truck with a set of processing units configured in a redundancy arrangement, wherein each set includes at least three processing units, wherein each processing unit of a same set is configured to execute application software, that was developed by three different software teams but with the same functionality goals, in separated and isolated memory segments and in one or more dedicated processors, that have been selected from different production batches, such that all three software applications should return an output (e.g. Xa, Xb, and Xc) which is to be equal (e.g. Xa=Xb=Xc) within given tolerances and wherein each set is communicatively coupled to a validator unit configured to monitor and compare the output of the processing units of the same set in order to determine whether each of the outputs indicates occurrence of the same event, wherein the validator unit is configured to identify a failing processing unit responsive to determining that the failing processing unit does not indicate the occurrence of the same event as the outputs of the other processing units of the same set that do indicate the occurrence of the same event, and wherein the cyber-physical system is configured to continue operation using the outputs of the other processing units of the same set and without using the different output generated by the failing processing unit of the same set.

According to some examples, the truck has multiple physical or virtual axles and for each physical or virtual axle, a group of processing units are arranged in redundancy arrangement, wherein each group linked to one physical or virtual axle is configured to receive data from different sensors and/or processing units linked to the respective one physical or virtual axle. The group of processing units may for instance be arranged in triple modular redundancy (TMR). The mathematical model of the dump truck relevant for the physical or virtual axle may be executed by the group of processing units in redundancy arrangement for said physical or virtual axle. Such a hardware topology can provide significantly enhanced reliability of operation of the dump truck resulting in a higher availability of the dump truck to the mining haulage process. Furthermore, the number of needed redundant hardware components can be reduced as the redundancy arrangements arranged for the plurality of physical or virtual axles can significantly enhance operational reliability of the dump truck. This arrangement provides a more effective redundancy configuration for the dump truck cyber-physical system.

By strategically arranging the processing units in a redundancy arrangement for each of the at least two physical or virtual axles of the dump truck, the cost of manufacturing the dump truck can be effectively reduced.

In some examples, the mathematical model of the dump truck is filtered for what happens to the physical or virtual axles. So, this provides strategic locations for monitoring a complex system-of-systems such as a multi-axle dump truck. Hence, the central processing unit (e.g. vertices 10 and 5 in the FIG. 10) can be coupled to physical or virtual axle 1 and axle 2 of a two-axle dump truck.

According to an aspect, the invention provides for a cyber-physical system of a dump truck according to the invention.

It will be appreciated that any of the aspects, features and options described in view of the dump truck apply equally to the cyber-physical system of a dump truck and the described methods. It will also be clear that any one or more of the above aspects, features and options can be combined.

Optionally, the dump truck is an off-highway dump truck.

According to an aspect, the invention provides for a self-regulating and self-learning cyber-physical system (CPS) of the dump truck that processes the datasets that it receives from the multitude of sensors in the different operational modes of the semi-autonomous or autonomous off-highway dump truck and that acts on the basis of the contents of the datasets. A model-based approach for controlling the mining dump truck is used by the cyber-physical system of the dump truck, where the mathematical model of the dump truck takes into account the detailed physics (e.g. truck inertia, rolling resistance, aerodynamic drag, slope of the route, coefficient of friction, tire dynamics, cornering, traction, environmental disturbances, state of charge of the battery . . . ) of driving a mining dump truck along the selected route in the mine. This allows for the optimization of the haulage mission. Our mathematical model of the dump truck is an integral part of the cyber-physical system of the hybrid electric autonomous or semi-autonomous off-highway dump truck for surface mining industry. The present invention results in improvements varying from 20 percent to 60 percent expressed in cost per (metric ton×hours) or in cost per (metric ton×km). Even in the case of the ‘wrong metric’, one obtains improvements of minimum 20 percent expressed in cost per metric ton. These improvements are considered a substantial change in the business models of the surface mining industry.

According to an aspect, the invention provides for a cyber-physical system (CPS) for an autonomous or semi-autonomous hybrid electric off-highway dump truck that is disclosed through its hardware layer in the form of a graph of vertices and edges where each vertex represents a system-on-chip (SoC or MPSoC) and each edge represents a bi-directional communication channel between two SoCs/MPSoCs and through its software layer in the form of a software model expressed in unified modelling language (UML), wherein a situational awareness system (SAS) is configured to generate an imaging dataset for processing by the cyber-physical system for enabling semi-autonomous or autonomous operational modes of the dump truck, wherein the cyber-physical system is at the core of a sensory system comprising:
a situational awareness system (SAS);
a battery management system (BMS);
a steering control system (SCS);
a driving control system (DCS);
a meteorological mast (MET).

The cyber-physical system of the dump is connected externally with the supervisor control unit (see FIG. 1 SCU) through a secure wireless communication system with internet-of-things (IoT) capabilities.

According to an aspect, the invention provides for a method for processing datasets from subunits of a sensory system, wherein the cyber-physical system of the dump truck processes the datasets to be used in the semi-autonomous or autonomous operation of the off-highway dump truck.

### BRIEF DESCRIPTION OF THE DRAWINGS

The foregoing and the following detailed description are better understood when read in conjunction with the appended drawings. For the purposes of illustration, examples are shown in the drawings; however, the subject matter is not limited to the specific elements and instrumentalities disclosed.

In the drawings:

FIG. 1 illustrates a side view of an exemplary embodiment of a cyber-physical hybrid electric autonomous or semi-autonomous dump truck with 3 virtual axles in a 12×12 configuration in accordance with aspects of the disclosure;

FIG. 2 illustrates the top-level block diagram of the cyber-physical system (CPS) of the dump truck and its connection to the situational awareness system (SAS) in the case of a 3 virtual axles 12×12×12 semi-autonomous hybrid electric mining dump truck;

FIG. 3 illustrates the vehicle control performed by the cyber-physical system (CPS) of the dump truck in the case of a 3 virtual axles 12×12×12 semi-autonomous hybrid electric mining dump truck;

FIG. 4 illustrates the interactions between the vehicle control and the situational awareness system (SAS) as controlled by the cyber-physical system (CPS) of the dump truck in the case of a 3 virtual axles 12×12×12 semi-autonomous hybrid electric mining dump truck;

FIG. 5 illustrates the interactions controlled by the cyber-physical system (CPS) of the dump truck with respect to the motion control of the mining dump truck in the case of a 3 virtual axles 12×12×12 semi-autonomous hybrid electric mining dump truck;

FIG. 6 illustrates the complete software architecture of the cyber-physical system (CPS) of the dump truck in the case of a 3 virtual axles 12×12×12 autonomous or semi-autonomous hybrid electric mining dump truck;

FIG. 7 illustrates the graph of the situational awareness system (SAS) where each vertex represents a SoC/MPSoC of the situational awareness system (SAS) that is interacting with the cyber-physical system (CPS) of an autonomous or semi-autonomous hybrid electric mining dump truck;

FIG. 8 shows the 2D representation of part of the core cyber-physical system (CPS) network architecture where each vertex represents one System-on-Chip (SoC/MPSoC) in a 20×20×20 autonomous or semi-autonomous hybrid electric mining dump truck configuration with 5 virtual axles;

FIG. 9 shows the complete cyber-physical system (CPS) network architecture where each vertex represents a System-on-Chip (SoC/MPSoC) in a 20×20×20 autonomous or semi-autonomous hybrid electric mining dump truck configuration with 5 virtual axles;

FIG. 10 shows the 2D representation of part of the core cyber-physical system (CPS) network architecture where each vertex represents one System-on-Chip (SoC/MPSoC) in a 8×8 autonomous or semi-autonomous hybrid electric mining dump truck configuration with 2 virtual axles;

FIG. 11 shows the 2D representation of part of the core cyber-physical system (CPS) network architecture where each vertex represents one System-on-Chip (SoC/MPSoC) in a 12×12×12 autonomous or semi-autonomous hybrid electric mining dump truck configuration with 3 virtual axles;

FIG. 12 shows the 2D representation of part of the core cyber-physical system (CPS) network architecture where each vertex represents one System-on-Chip (SoC/MPSoC) in a 16×16×16 autonomous or semi-autonomous hybrid electric mining dump truck configuration with 4 virtual axles;

FIG. 13 shows the reliability equation R(t, m, MTTF)-0.999=0 for the cyber-physical system (CPS) of the autonomous or semi-autonomous hybrid electric mining dump truck as function of the operating time t, the number of vertices m and the mean-time-to-failure (MTTF) of the vertex;

FIG. 14 illustrates the architecture of the connection of the autonomous or semi-autonomous hybrid electric mining dump truck with the Internet-of-Things (IoT) in accordance with aspects of the disclosure;

FIG. 15 illustrates a ruggedized Ethernet switch being one of the 10 switch modules used by the data synchronization unit (DSU);

FIG. 16 shows an exemplary network architectures of cyber-physical systems of vehicles;

FIG. 17 shows an exemplary network architecture of a cyber-physical system of a vehicle; and

FIG. 18 shows an exemplary network architecture of a cyber-physical system of a vehicle.

### DESCRIPTION OF EMBODIMENTS

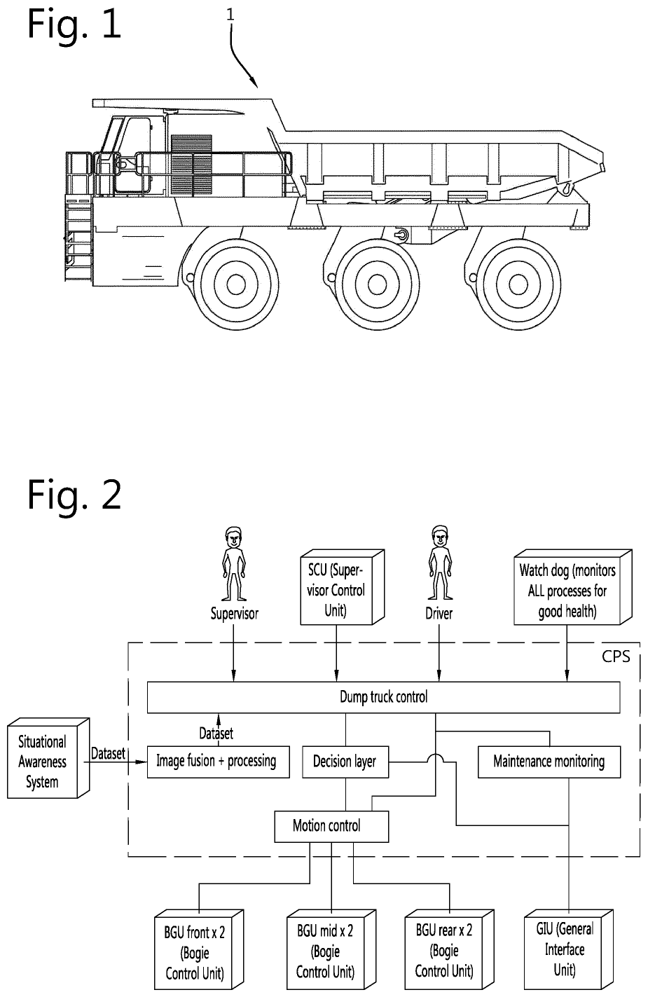

The present invention discloses a cyber-physical system (CPS) that processes and controls the datasets that it receives from the multitude of sensors in the different operational modes of the semi-autonomous or autonomous off-highway dump truck. The dump truck can be classified as an all-wheels drive (AWD) and all-wheels steer (AWS) dump truck with chassis configuration A×B×C, where A is the number of wheels, B the number of driven wheels and C the number of steered wheels. The hybrid electric dump truck, controlled by the cyber-physical system, is a multi-axle truck. Each physical or virtual axle can be equipped with two independently vertically rotating bogies that each have two individual wheel drives (IWD). Each bogie may contain two synchronous electric AC drive electric motors connected to a multi-stage hub reduction gearbox. FIG. 1 shows a mining dump truck, controlled by a cyber-physical system, with three virtual axles in a 12×12×12 configuration. The exemplary embodiment provides a removable cabin, engine modules, axles, crossbeams, rotary hydrostatic bearings, hoist cylinders, bogies, a central frame, and a dump body. The tipping of the dump body is controlled by the cyber-physical system. The cyber-physical system monitors the attitude of the dump truck with respect to its environment and more specifically uneven ground conditions such that no rollover of the dump truck can occur while performing the dumping of the payload. This can be done by anticipating the changes in the centre of gravity of the dump truck while performing the tipping action and dumping action. The cyber-physical system of the dump truck analyses the shifts in the centre of gravity in real-time by recording electro-optically as well as by electronic cells, the changes in the loads of the bogies. Quickly acting on this analysis can effectively prevent accidents with the mining dump truck. In some advantageous embodiments, the autonomous or semi-autonomous dump truck is a high reliability system. Reliability can be defined as the probability that a system will not fail under specified conditions. The conditions are dictated by the harsh environment encountered in surface mines worldwide. To obtain a high reliability it is desired to build a redundant cyber-physical system of the dump truck that processes the datasets coming from the sensory system and that commands the multitude of actuators on the dump truck to move from one machine state to another machine state and reporting this new machine state to the core of the cyber-physical system of the dump truck. Autonomous and semi-autonomous dump trucks have at the core of their system voting circuitry and a lot of interconnections of logical elements. A well-known technique to increase the reliability of a good system is to use triple modular redundancy (TMR). The redundant system may not fail if none of the three modules fails, or if exactly one of the three modules fails under the assumption that the voting circuit does not fail.

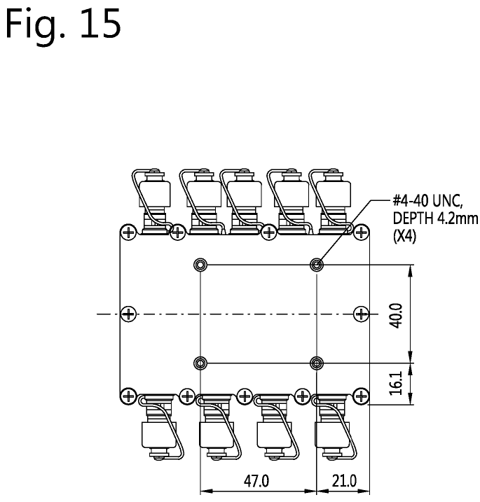

The data synchronization unit (DSU) is that part of the situational awareness system (SAS) that guarantees the timely correct delivery of the dataset to the cyber-physical system of the dump truck. The reference clock of the data synchronization unit, that is distributed all over the situational awareness system (SAS), can be derived from the resilient master clock of the cyber-physical system (CPS) of the dump truck. The data synchronization unit (DSU) can be equipped with 10 ruggedized (MIL-STD-1275, MIL-STD-704A, MIL-STD461E, MIL-STD-810F GM, IP67/68) Ethernet switches, as shown in FIG. 15, having each 8×10/100/1000 Ethernet data ports. The detailed minimum requirements for the 80 data ports are given in Table 1 where the subunits of the situational awareness system are given in the rows. The subunits of the situational awareness system can be each equipped with a SoC/MPSoC and can be considered as vertices of the cyber-physical system (CPS) distributed network topology of the dump truck. The subunits of the SAS may be: the long-range electro-optical unit (LEOU), the short-range electro-optical unit (SEOU), the ground-looking proximity unit (GEOU), the lower deck unit (LDU), the dump body inspection unit (DBIU), the radar unit (RU) and the data synchronization unit (DSU). The data synchronization unit (DSU) can be equipped with a set of system-on-a-chip (SoC/MPSoC) devices comprising each of two major blocks: a processing system (PS) and a programmable logic (PL) block where the field-programmable gate array (FPGA) is located. The computationally intensive operations are coded within the FPGA fabric. Real-time image processing operations are executed on the SoCs/MPSoCs prior to the creation of the final dataset to be transferred to the cyber-physical system (CPS) of the dump truck.

The connectivity of the situational awareness system with the cyber-physical system (CPS) can be through the data synchronization unit (DSU).

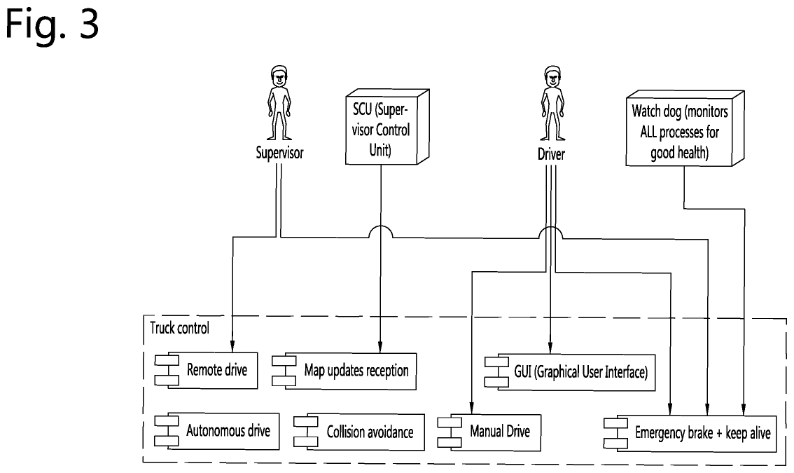

The software layer of the cyber-physical system of the dump truck can be embedded in hardware. An exemplary software architecture of the cyber-physical system of the dump truck is illustrated in FIG. 2. A more detailed example is shown in FIGS. 3, 4 and 5. The software on which the mathematical model of the dump truck is executed can be embedded software (cf. firmware). The software modules may be implemented in SoC/MPSoC processing units. However, other embodiments using other hardware components are also envisaged.

TABLE 1

| | | | | | | | | Data |
|---|---|---|---|---|---|---|---|---|
| | | Data | | | | Number | Data | rate[bit/s] |
| Subunit | Channel | bit depth | #Hpixels | #Vpixels | Frames/s | Of Subunits | rate[bit/s] | per switch port |
| LEOU | LWIR | 14 | 640 | 480 | 25 | 4 | 430,080,000 | 107,520,000 |
| LEOU | SWIR | 12 | 640 | 512 | 25 | 4 | 393,216,000 | 98,304,000 |
| LEOU | VISNIR | 10 | 2048 | 2048 | 25 | 4 | 4,194,304,000 | 1,048,576,000 |
| SEOU | VISNIR | 12 | 2048 | 1088 | 25 | 16 | 10,695,475,200 | 668,467,200 |
| GEOU | VISNIR | 10 | 1920 | 1200 | 25 | 6 | 3,456,000,000 | 576,000,000 |
| LDU | LWIR | 14 | 640 | 480 | 25 | 10 | 1,075,200,000 | 107,520,000 |
| LDU | VISNIR | 10 | 1920 | 1200 | 25 | 10 | 5,760,000,000 | 576,000,000 |
| DBIU | LWIR | 14 | 640 | 480 | 25 | 1 | 107,520,000 | 107,520,000 |
| DBIU | VISNIR | 10 | 1920 | 1200 | 25 | 1 | 576,000,000 | 576,000,000 |
| RU | RADAR | — | — | — | 30 | 2 | 2,000,000,000 | 1,000,000,000 |
| | | | | | | 58 | 28,687,795,200 | |

The dataset generated by the situational awareness system (SAS) of the dump truck may contain position vectors, velocity vectors and acceleration vectors of relevant objects with respect to the local coordinate system of the mining dump truck. These relevant objects can be measured and calculated by the systems-on-chip (SoC/MPSoC) of the cyber-physical system of the dump truck. The output of these calculations can be used by an algorithm of the cyber-physical system of the dump truck that results in the proper actions (braking, steering, cornering . . . ) to be taken by the mining dump truck.

The use of an 24/7 all-weather situational awareness system (SAS), providing a data set to the cyber-physical system (CPS) of the dump truck increases the availability of the dump truck for the mining company and result in a substantial increase of the throughput of the mining company.

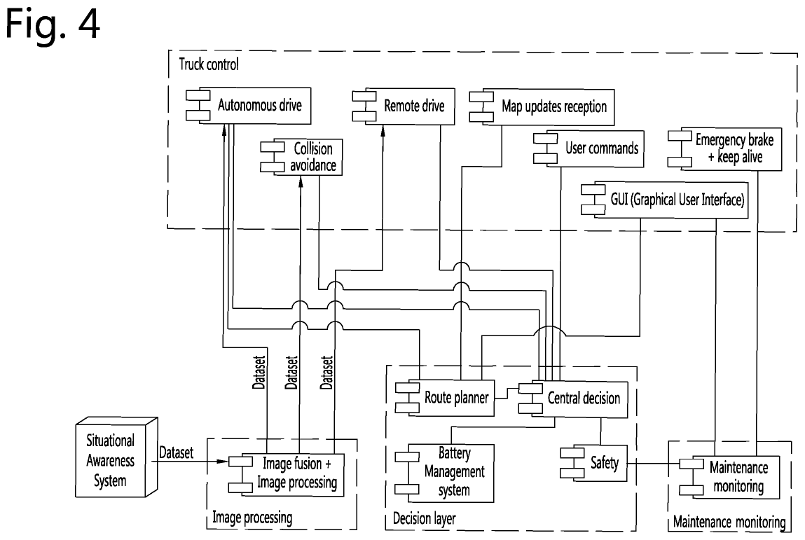

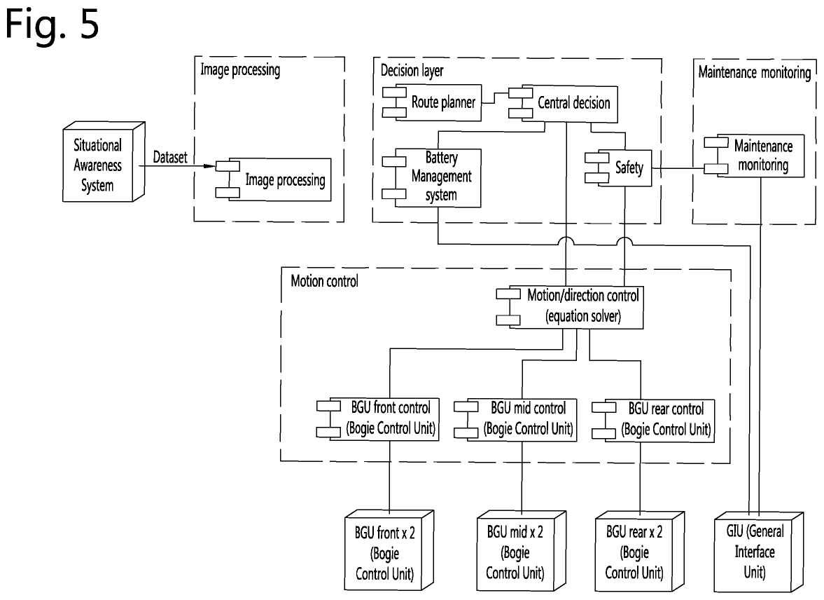

In an exemplary embodiment, the dump truck is provided with a cyber-physical systems backbone. The cyber-physical systems backbone of the dump truck may include a physical layer, a network/platform layer, and a software layer. The software layer in the exemplary embodiment can be detailed using unified modelling language (UML). FIG. 2 shows a top-level representation of the software layer of the cyber-physical system (CPS) of the dump truck in the case of a 3 virtual axles 12×12×12 autonomous or semi-autonomous hybrid electric mining dump truck. FIG. 3 shows a schematic representation of the dump truck control software performed by the cyber-physical system (CPS) of the dump truck in the case of a 3 virtual axles 12×12×12 autonomous or semi-autonomous hybrid electric mining dump truck. FIG. 4 shows the software interactions between the dump truck control and the situational awareness system (SAS) as controlled by the cyber-physical system (CPS) of the dump truck in the case of a 3 virtual axles 12×12×12 autonomous or semi-autonomous hybrid electric mining dump truck. FIG. 5 represents the interactions controlled by the software layer of the cyber-physical system (CPS) of the dump truck with respect to the motion control of the dump truck in the case of a 3 virtual axles 12×12×12 autonomous or semi-autonomous hybrid electric mining dump truck.

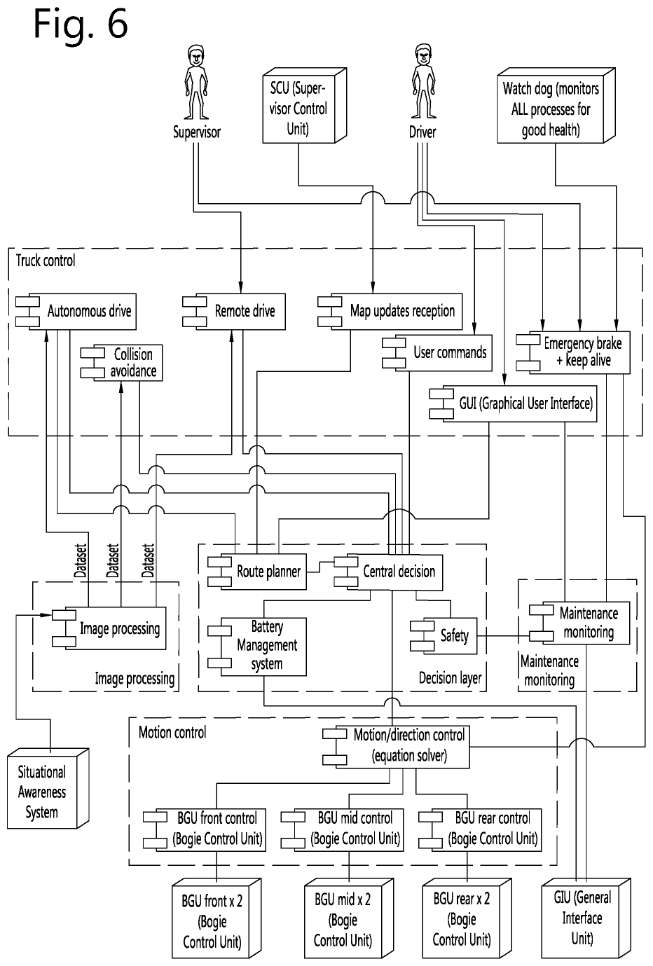

FIG. 6 gives an overall schematics of the software layer of the cyber-physical system (CPS) of the dump truck in the case of a 3 virtual axles 12×12×12 autonomous or semi-autonomous hybrid electric mining dump truck. Similar schematics are obtained for an autonomous hybrid electric mining dump trucks and that also for other multi-axle configurations.

The situational awareness system (SAS), the inertial navigation system (INS), the steering control system (SCS) and the driving control systems (DCS) are important inputs to the cyber-physical system (CPS) of the mining dump truck that operates like a system-of-systems (SoS).

The cyber-physical system of the dump truck may be configured to use artificial intelligence (AI) algorithms and/or artificial neural network (ANN) methods and/or machine learning (ML) techniques when creating a perception of the physical space and the cyber space in which the mining dump truck operates.

The core of the cyber-physical system (CPS) of the dump truck may comprise three physically independent System-on-Chip (SoC) or multi-processor System-on-Chip (MPSoC) executing each three equal software/firmware applications denoted Aᵢ, Bᵢ and Cᵢ, where the subscript indicates the physical SoC/MPSoC number i=1, 2, 3. The software/firmware applications result in controlling the machine states of the mining dump truck comprising a health monitoring algorithm of the SoCs/MPSoCs. The machine states can be encoded in the software using a Hamming distance of two or three to detect and correct machine states that are affected by a single event upset (SEU). FIG. 6 gives the overall software architecture in unified modelling language (UML) of the cyber-physical system (CPS) of the dump truck. The SoC₁, SoC₂ and SoC₃ originate from different production batches to increase the reliability. The embedded software that operates in parallel is developed by three independent firmware teams to increase the software reliability. The SoC₁, SoC₂ and SoC₃ are connected to a resilient master clock located outside of the SoCs. This resilient master clock is also connected to the situational awareness system (SAS) through the data synchronization unit (DSU) where it further propagates to the submodules of the situational awareness system (SAS). The voting circuitry is located outside of the three SoCs in a high-reliability electronics module. Enough redundancy is built-in in the voting circuitry and the redundant hardware parts of the voting circuitry are originating from different production batches. The triple modular redundancy (TMR) applied to the SoCs guarantees that the mining dump truck continues to operate in a correct way when a malfunction occurs in one SoC.

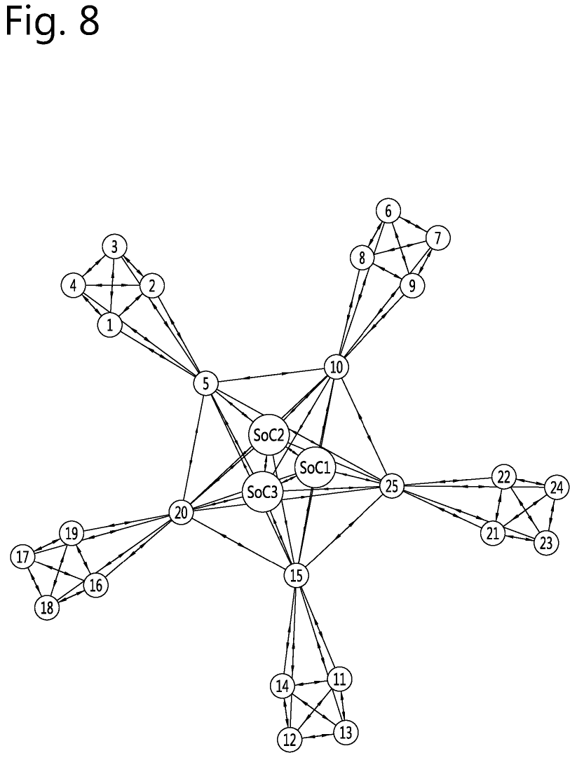

FIG. 8 illustrates the vertices and edges graph/topology of a preferred embodiment of the cyber-physical system (CPS) of a five virtual axles hybrid mining dump truck having a 20×20×20 truck configuration. The core SoCs are indicated by the vertices {SoC₁, SoC₂, SoC₃} and these vertices are placed in a wheel topology. The five virtual axles have each a 5 vertices wheel topology. The topology connecting the vertices {1, 2, 3, 4, 5} is representative for virtual axle 1, the topology connecting the vertices {6, 7, 8, 9, 10} is representative for virtual axle 2, the topology connecting the vertices {11, 12, 13, 14, 15} is representative for virtual axle 3, the topology connecting the vertices {16, 17, 18, 19, 20} is representative for virtual axle 4, the topology connecting the vertices {21, 22, 23, 24, 25} is representative for virtual axle 5. The topology connecting the vertices {5, 10, 15, 20, 25, SoC1, SoC2, SoC3} is representative for the backbone of the cyber-physical system (CPS) of the mining dump truck. The vertices {1, 2, 3, 4} represent computing devices (e.g. SoC/MPSoC) managing the machine state of the individual wheels of the first virtual axle. The computing device for the first outer wheel left is denoted {1}, the computing device for the first inner wheel left is denoted {2}, the computing device for the first inner wheel right is denoted {3} and the computing device for the first outer wheel right is denoted {4}. These four computing devices (SoC/MPSoC) receive inputs from sensors connected the wheel subsystem. These sensors are measuring a variety of parameters of the wheels (position, velocity, acceleration, angular acceleration, tire pressure, gearbox status, suspension status, electrical motor status, inverter status, associated battery pack status, motoring status . . . ) and provide this information to the mathematical model of the specific wheel that is embedded in the respective computing units represented by the vertices {1, 2, 3, 4}. The associated battery pack contains a dedicated battery management system (BMS) that communicates with that specific vertex. The associated battery pack provides easy upgradability when battery technology advances. The battery technology advances are reflected in an upgrading of the mathematical model of the dump truck embedded in the cores of the cyber-physical system. The respective computing devices vertices {1, 2, 3, 4} compare the respective state of the wheel with the pre-calculated state and perform the necessary corrections and communicates this state to the virtual axle 1 consolidating computing unit given by vertex {5}. The triple modular redundancy arrangement is reflected in the pyramidal construction where the vertices {1, 2, 3, 4} are connected to vertex {5}. The vertex {5} communicates the state of virtual axle 1 to the core of the cyber-physical system (CPS) represented by the vertices {SoC₁, SoC₂, SoC₃}. Similarly, the vertex {10} communicates the state of virtual axle 2, the vertex {15} communicates the state of virtual axle 3, the vertex {20} communicates the state of virtual axle 4 and the vertex {25} communicates the state of virtual axle 5 to the core of the cyber-physical system(CPS) represented by the vertices {SoC₁, SoC₂, SoC₃}.

The top vertices {5, 10, 15, 20, 25} of each pyramidal graph controls the movement of 2 bogies mounted on each of the virtual axles of the mining dump truck. Each bogie can receive the command from the cyber-physical system (CPS) to lift-up the wheels from the ground. This functionality of the bogie allows in the case of a damaged tire to drive the mining dump truck with retracted bogie to the maintenance bay. Each bogie is equipped with an active suspension that is modelled as a MIMO system with 2 inputs and 3 outputs. The control of the two MIMO systems for each virtual axle is performed in the central vertex of the wheel topology of the respective virtual axle. The above-mentioned wheel topology for a virtual axle is repeated for each virtual axle of the mining dump truck.

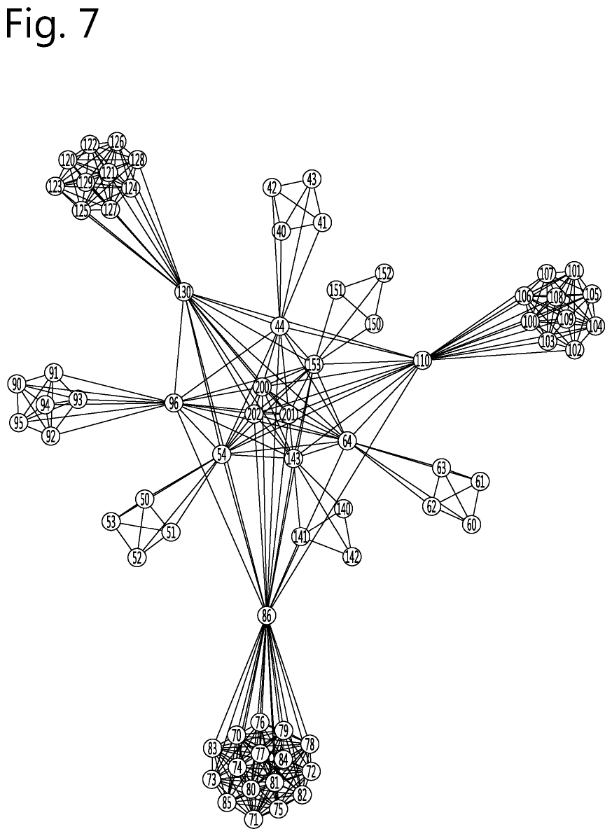

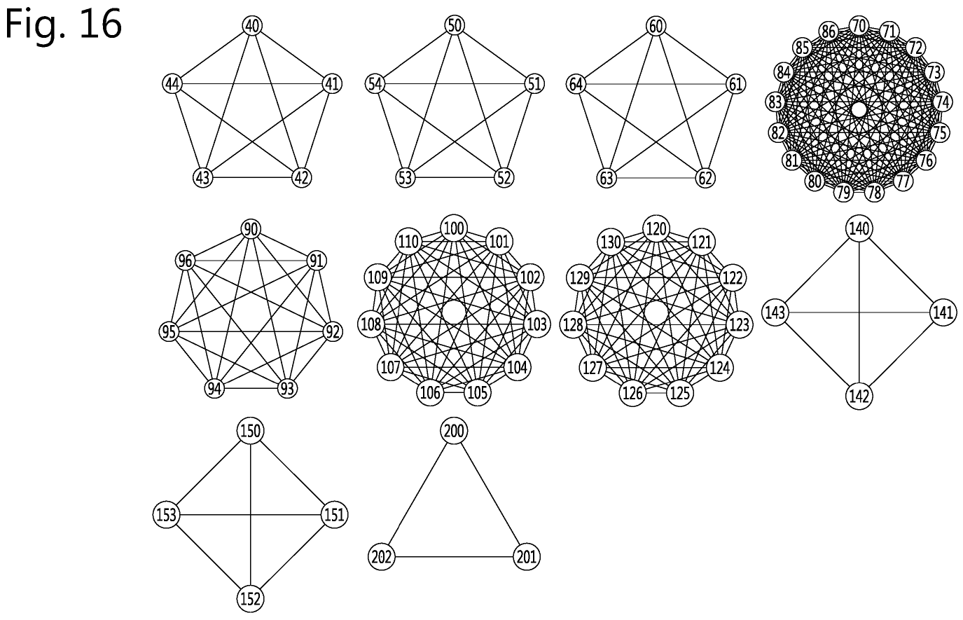

FIG. 7 illustrates the overall graph of a preferred embodiment of the situational awareness system (SAS) where each vertex represents a SoC of the SAS and each edge represents in a preferred embodiment a bi-directional communication line between two network components (e.g. processing units). FIG. 16 shows the preferred sub-graphs of the ten submodules of a preferred embodiment of the situational awareness system (SAS). The topology connecting the vertices {40,41,42,43,44} is representative for the visible and near-infrared (VISNIR) channel of the long-range electro-optical unit (LEOU), the topology connecting the vertices {50,51,52,53,54} is representative for the short-wave infrared (SWIR) channel of the long-range electro-optical unit (LEOU), the topology connecting the vertices {60,61,62,63,64} is representative for the long-wave infrared (LWIR) channel of the long-range electro-optical unit (LEOU), the topology connecting the vertices {70,71,72,73,74,75,76,77,78,79,80,81,82,83,84,85,86} is representative for the short-range electro-optical unit (SEOU), the topology connecting the vertices {90,91,92,93,94,95,96} is representative for the ground-looking electro-optical unit (GEOU), the topology connecting the vertices {100,101,102,103,104,105,106,107,108,109,110} is representative for the visible and near-infrared (VISNIR) channel of the lower deck unit (LDU), the topology connecting the vertices {120,121,122,123,124,125,126,127,128,129,130} is representative for the long-wave infrared (LWIR) channel of the lower deck unit (LDU), the topology connecting the vertices {140,141,142,143} is representative for the visible and near-infrared (VISNIR) channel of the dump body inspection unit (DBIU), the topology connecting the vertices {150,151,152,153} is representative for the long-wave infrared (LWIR) channel of the dump body inspection unit (DBIU), the topology connecting the vertices {200,201,202} is representative for the radar unit (RU). The connection of the subsystems of the situational awareness systems (SAS) is performed by the topology connecting the vertices {44,54,64,86,96,110,130,143,153,202} and forming the core of the data synchronization unit (DSU). The situational awareness systems as shown in FIG. 7 is a preferred embodiment to provide the “eyes” to the cyber-physical system (CPS) being the “brains” of the mining dump truck. The situational awareness system (SAS) is robust against single point failure (SPF) at the level of the vertices and the edges and it is shown at subsystem level in FIG. 16 to have a wheel topology.

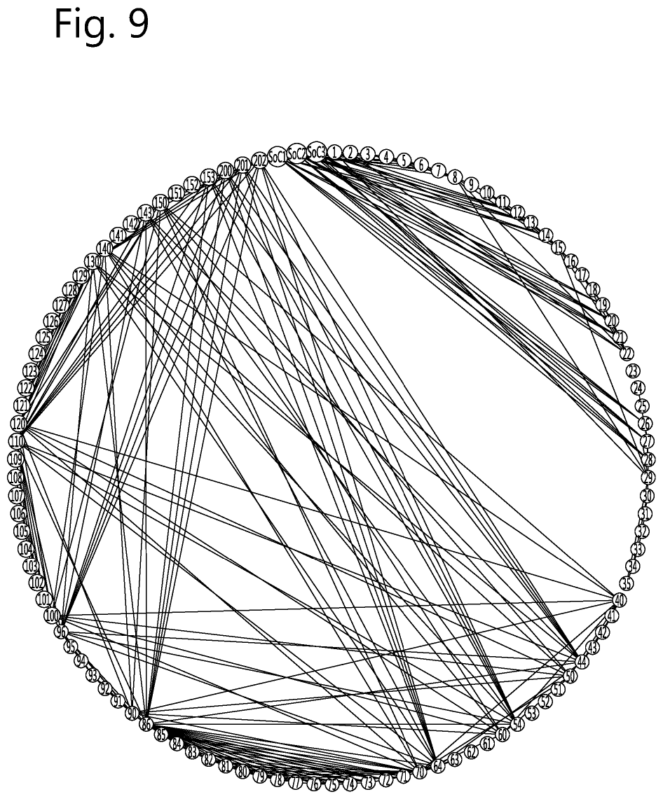

FIG. 9 gives a detailed network graph of a preferred embodiment of a cyber-physical system (CPS) for a 20×20×20 truck configuration where the vertices of FIG. 8 have been combined to the vertices of FIG. 7.

This overall topology given in FIG. 9 for the case of a 20×20×20 truck configuration forms the minimum network requirements to solve the availability problem of existing mining dump trucks. FIG. 9 is the base to the design of generic autonomous and semi-autonomous hybrid mining dump trucks with high availability due to the robustness of the network topology to defects at the levels of the vertices and edges of the graph. The graph of FIG. 9 represents the complete CPS and contains at least 100 vertices and 1000 edges, showing that the cyber-physical system is forming the backbone of this cyber-physical autonomous or semi-autonomous hybrid electric off-highway mining dump truck.

The network of processing units as shown in FIG. 9 provides an example of the hardware layer of the cyber-physical system. The processing units may relate to each other forming a distributed network of processing units and/or computers. The invention provides for an improved way of distributing the processing units (e.g. computer units) over the dump truck (cf. network architecture) while significantly increasing the reliability and/or robustness of the cyber-physical system.

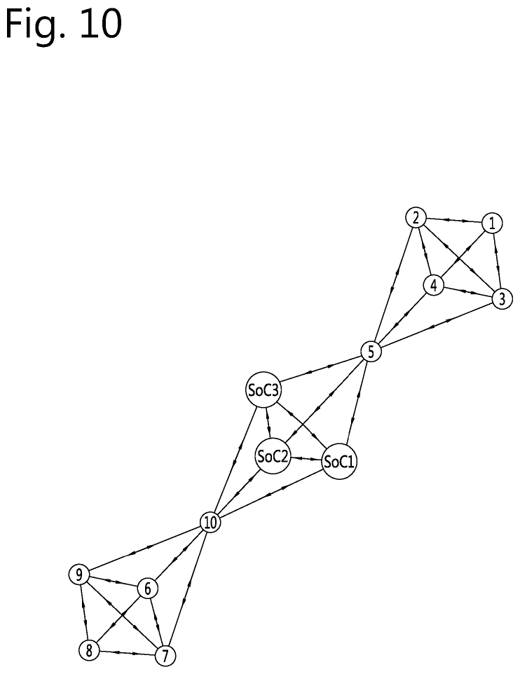

FIG. 10 shows the graph of a cyber-physical system corresponding to the 8×8×8 truck configuration with 2 virtual axles without the connection to the situational awareness system (SAS) graph. For examples, processing units indicated by vertices 1, 2, 3 and 4 can be dedicated to the first virtual axle of the dump truck, and processing units indicated by vertices 6, 7, 8 and 9 can be dedicated to the second virtual axle of the dump truck. In some advantageous embodiments, the processing units indicated by vertices 1, 2, 3 and 4 are arranged at or adjacent to the first virtual axle of the dump truck, and the processing units indicated by vertices 6, 7, 8 and 9 are arranged at or adjacent to the second virtual axle of the dump truck. For example, the first virtual axle may have four wheels, and for each wheel a dedicated processing unit may be used. Further, the second virtual axle may also have four wheels, e.g. each have dedicated processing units. In some examples, each wheel of the mining dump truck has its own dedicated system-on-chip (SoC). Each wheel of the mining dump truck can be driven by an individual motor, and each individual motor may be controlled by a processing unit (providing control signals). For example, a first wheel and a second wheel of a physical or virtual axle of a dump truck may behave differently and can be controlled by a different separate processing unit. Should one of the processing units fail, the three other wheels may remain operational. The failing wheel may for instance be put in a freewheeling state (e.g. idle mode), but the mining dump truck can remain safe. The other wheels may perform a compensating action such as to compensate for the failing wheel.

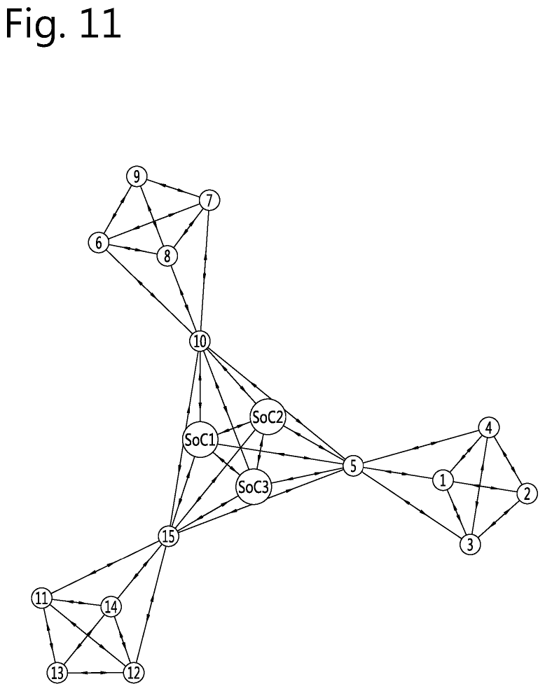

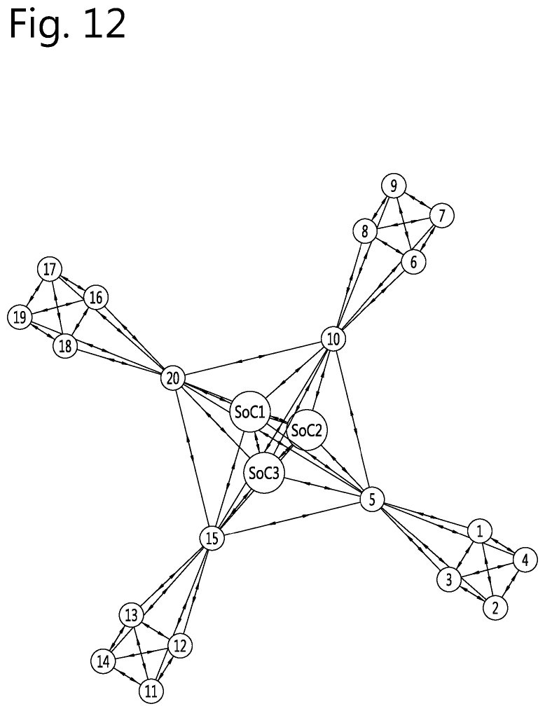

Similar graphs can be obtained for the 12×12×12 truck configuration with 3 virtual axles as shown in FIG. 11 and the 16×16×16 truck configuration with 4 virtual axles as shown in FIG. 12.

The processing unit dedicated to a particular wheel may be a controller configured for controlling the wheel. Such a controller may be implemented as a system-on-chip (SoC/MPSoC) having various functions. Exemplary functions of the controller are wheel control, processing of measured data from sensors (accelerometer, vision system, navigation system, gyroscope, wheel pressure), et cetera. A wheel network topology may be employed. For instance in FIG. 10, if the edge between vertices 1 and 2 is interrupted, there is still communication possible between vertices 1 and 2, e.g. through vertices 1, 4 and 2 or through vertices 1, 3 and 2 (cf. pyramidal 3D drawing with a square base). It will be appreciated that the figure FIG. 10 provides an exemplary network topology. Various other topologies can be employed for the dump truck. For example, the connection to the situational awareness system (SAS) of the dump truck (e.g. vision system) is not shown.

In the example shown in FIG. 10, the processing units represented by vertices 1, 2, 3, 4 are linked to a respective wheel, and the processing unit represented by vertex 5 is configured to coordinate all data from the first virtual axle of the dump truck. Similarly, the processing unit represented by vertex 10 coordinates all data of the second virtual axle.

Vertices 1, 2, 3 and 4 may represent processing units which are each linked to one different wheel of a first virtual axle. Vertex 5 may represent the processing unit of the first virtual axle which is configured to coordinate all data for the first virtual axle. Similarly, vertex 10 may represent the processing unit which is configured to coordinate all data from a second virtual axle. Coordinated data may be time stamped for example by a resilient master clock unit. In some advantageous embodiments, the vertices 5 and 10 representing processing units performing coordination of units of respectively the first virtual axle and the second virtual axle, are physically installed at the first virtual axle and the second virtual axle, respectively.

The cyber-physical system (CPS) has a multi-sensor integrated navigation functionality, based on inputs from GNSS, GPS, INS, odometer, magnetic compass, barometric sensor, laser ranging data (ELRF) and the digital terrain map (DTM). The cyber-physical system (CPS) can retrieve the exact position of the wheels in the earth-centered earth-fixed (ECEF) coordination system due to the fixed position of the wheels with respect to their respective inertial measurement units. The 3D coordinates of the wheels are used by the cyber-physical system to steer the truck along the predetermined optimum path. This predetermined path is created based on the data of the digital terrain map (DTM). This digital terrain map (DTM) is obtained by combining satellite data and surveying data of the mine layout. The satellite data could be based on WorldView-2 using the WGS84 reference system. The contour data can be given in vector format while the digital elevation model (DEM) of the survey data could be in ASCII XYZ format. The digital terrain map (DTM) has a nominal resolution of 0.5 m on the bare earth survey grid with a 0.2 m relative vertical accuracy and a resolution of 1 m in the contour lines. The steering of the wheels is functional over an angular range of −90° to +900 which allows the truck to perform crab displacement by moving in lateral direction. This capability allows precise alignment and centration of the truck's dump body with respect to the position of a loader and/or loader-excavator in the surface mine. The accurate positioning is controlled by the cyber-physical system (CPS). Crab displacements require large angular rotations. During the initialization phase of the crab displacement, the bogies could be lifted sequentially up while the bogie is rotated to a −90° or +90° angle. Once the dump truck has finished the crab displacement initialization, the steering can be continued to position the truck at the optimal position for the loading or dumping action.

The large steering angle range of the truck reduces its turning diameter minimizing the footprint of the dump truck in the surface mine.

The dump truck has an electric drivetrain where the torque on each wheel is controlled by the cyber-physical system (CPS) such that an optimum traction can be obtained as function of the environmental conditions as well as on the composition and physical conditions of the soil. The exact position of each wheel is detected through an inertial measurement unit (IMU) mounted close to the wheel. The information of each inertial measurement unit is transferred to the inertial navigation system (INS) that is connected to the cyber-physical system (CPS) of the mining dump truck.

The mechanical faults (bearing faults, rotor unbalance, misalignment) of the electrical motor are monitored by the cyber-physical system (CPS) through motor current signature analysis (MCSA). The monitored current is the stator current. Deviations with respect to the nominal machine status can be used by the cyber-physical system (CPS) to generate preventive maintenance alerts.

Heat is dissipated on the mining dump truck through adjustable speed fan assisted coolers. The fans are controlled by the cyber-physical system (CPS) of the mining dump truck.

The mining dump truck is equipped with a meteorological mast (MET) providing the cyber-physical system (CPS) with the local actual environmental conditions (temperature, relative humidity, rain, wind, solar radiation, pressure, . . . ).

These local actual environmental conditions are taken into consideration by the cyber-physical system (CPS) to optimize the traction of the truck, resulting in an improvement of the overall performance. These local actual environmental conditions are used by the artificial intelligence (AI) module and/or artificial neural network (ANN) of the cyber-physical system(CPS) to adjust the mathematical model of the truck for the selected round-trip route in the surface mine.

The cyber-physical system(CPS) of the mining dump truck has an on-board diagnostic system (OBD) that has the capability of detecting, recording and communicating failures of the mining dump truck to externally fleet supervisors (SCU) as shown in FIG. 2 that affect environmental performance, safety and security. The external communication with the fleet supervisor control unit (SCU) is done according to cybersecurity rules and guidelines.

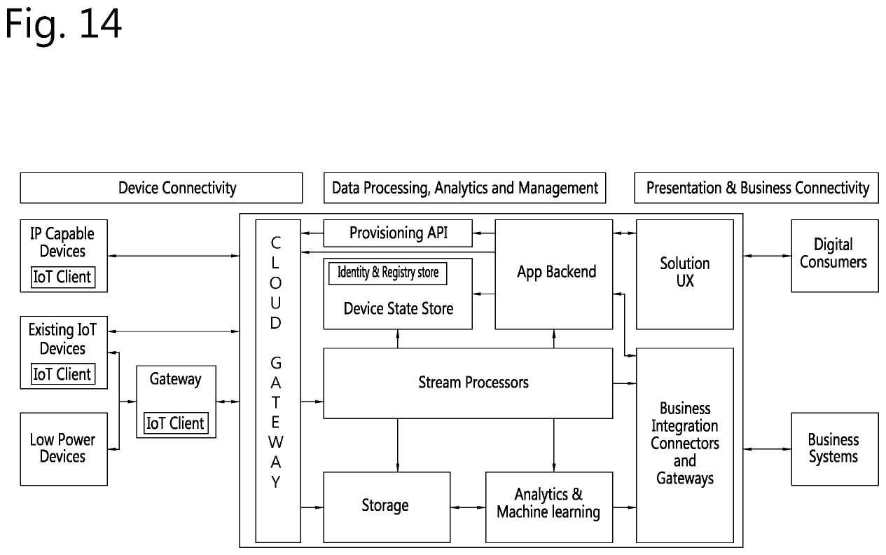

The cyber-physical system records and analyzes data of the connected units for the purpose of preventive maintenance. The cyber-physical system creates a map containing the predicted dates of failure of the different units. This information is made available to the fleet supervisors (SCU) directly or through Internet-of-Things features as given schematically in FIG. 14.

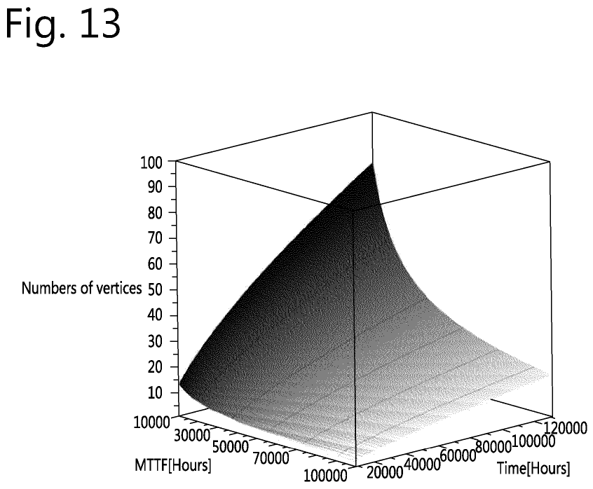

FIG. 13 shows the reliability equation R(t, m, MTTF)-0.999=0 as function of the operating time t expressed in hours, the number of vertices m and the mean-time-to-failure (MTTF) of the vertex expressed in hours. The value of 0.999 in the above-mentioned equation corresponds to a required CPS reliability of 99.9%. The mining dump truck can easily be reconfigured for another task by modifying its modular power pack units (PPU) and battery system as well as selecting new round-trip trajectories in the digital terrain map(DTM) that need to be covered by the mining dump truck. The optimization of these modes of operation is performed by the cyber-physical system (CPS) of the mining dump truck.

The dump time and the load time are important parameters in the optimization of the dump truck modes of operation. The typical dump time is 160 s, and the typical load time is 310 s for a truck of 240 metric ton. At these events, the battery modules can be charged while the truck is not moving. The cyber-physical system optimizes the charging time as being a fraction of the load time of the truck. This fraction of the load time is selected such that the difference between energy generated and energy consumed over one round trip is approximately zero. This round-trip energy value being approximately zero is the optimum for any electric hybrid mining dump truck. This optimization objective is only achievable when using a cyber-physical hybrid electric autonomous or semi-autonomous (ASAM) off-highway dump truck. The cyber-physical system (CPS) readjusts the fraction of the load time after having monitored the state of charge (SOC) of the battery pack at each round trip.

The optimal approach is the creation of a mathematical model of the dump truck operating in the complete haulage process. This mathematical model of the dump truck is based on parameters that are fixed by the mine layout and its time evolution, the soil type, the type of ore/overburden hauled, the environmental conditions and the design parameters of the mining dump truck and the total cost of ownership (TCO) of the mining dump truck. Optimization of this haulage problem results in a performance parameter that can be expressed in $/(metric ton×hours) or $/(metric ton×km) on a yearly basis. So, time or range enter the key performance indicator. The throughput performance indicators of the haulage process are the major concern of the mine manager. One of the performance indicators with the largest impact on the throughput is the availability of the dump truck for the haulage process of a surface mine. The invention discloses such a cyber-physical system that maximizes the availability of the electric hybrid autonomous or semi-autonomous dump truck for the haulage process of a surface mine

The above-mentioned mathematical model of the dump truck can be included in the core {SoC1, SoC2, SoC3} of the cyber-physical system (CPS) of the mining dump truck. The mathematical model of the dump truck can be configured to predict the overall required energy, the overall required power and the required rate of change of power of the energy storage unit based on the predetermined round-trip path in the surface mine and its cyclic pattern. These values are the nominal states for the cyber-physical system (CPS) of the mining dump truck disclosed in this invention. These values determine the mining dump truck hybrid energy configuration.

The cyber-physical electric hybrid autonomous or semi-autonomous (ASAM) off-highway mining dump truck results in less stressful work situations for the driver and thus decreasing the number of accidents in the mine.

The cyber-physical electric hybrid autonomous or semi-autonomous (ASAM) off-highway mining dump truck reduces the inter-driver dispersion of operation of the truck and thus increases the overall throughput for the mining company.

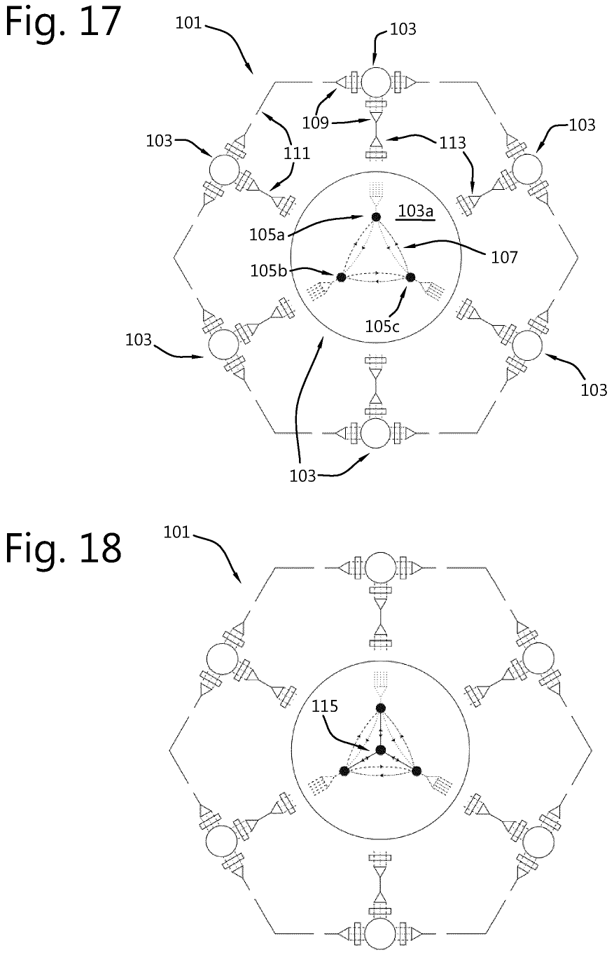

FIGS. 17 and 18 show an exemplary network architecture of a cyber-physical system 101 of a vehicle. The figures show cyber physical systems 101 with a wheel topology network. The vertices 103 (cf. nodes) in the wheel network are indicated by circles. In the figures, a central vertex 103a may have a first embedded system 105a, a second embedded system 105b and a third embedded system 105c dedicated to processing of data communicated using light with the first wavelength, light with the second wavelength, and light with the third wavelength, respectively. In some examples laser diodes are used for generating light of the first, second and third wavelength. The first embedded system 105a of the central computing unit 103a may be configured to transmit/receive signals conveyed using light with the first wavelength. Similarly, the second embedded system 105b of the central computing unit 103a may be configured to transmit/receive signals conveyed using light with the second wavelength; and the third embedded system 105c of the central computing unit 103a may be configured to transmit/receive signals conveyed using light with the third wavelength. Furthermore, the first embedded system 105a transmits signals to the second embedded system 105b and the third embedded system 105c. Similarly, the second embedded system 105b transmits signals to the first embedded system 105a and the third embedded system 105c; and the third embedded system 105c transmits signals to the first embedded system 105a and the second embedded system 105b. As shown in the figure, a total of six connection lines 107 are used for conveying signals between the three embedded systems of the central computing unit (central vertex), namely between the first, second and third embedded system 105a, 105b, 105c of the central computing unit 103a (central vertex). More particularly, two lines are arranged to carry signals using a waveguide for light with the first wavelength; two lines are arranged to carry signals using a waveguide for light with the second wavelength; and two lines arranged to carry signals using a waveguide for light with the third wavelength, respectively indicated by dashed, dotted and dash-dotted lines in the figure.

Each of the three embedded systems 105a, 105b, 105c of the central computing unit 103a are connected by means of fibre-optic cables to a multiplexer-demultiplexer. The multiplexer may be configured to pair plurality of signals coming from the embedded systems surrounding the central computing unit (i.e. vertices around the central vertex, on the outer ring of the wheel network). Only six vertices 103 are illustrated around the central vertex 103a. However, it will be appreciated that a different number of vertices 103 may be arranged in the ring of the wheel network (i.e. around the central vertex).

Multiplexers 109 may be used for combining electromagnetic/optical signals. The combined optical signals can be transmitted on fibre-optic lines 111. De-multiplexers 113 may be used for separating optical signals. A plurality of optical light signals with different wavelengths can be used. In this example, three different light signals with different wavelengths are used (e.g. ‘red’, ‘green’, and ‘blue’) indicated by dashed lines, dotted lines, and dash-dotted lines.

In the figure, light signals with three different wavelengths are coupled in glass fibre lines 111. Fibre-optic lines configured to convey light with a first wavelength are marked with a dashed line; fibre-optic lines configured to convey light with a second wavelength are marked with a dotted line; and fibre-optic lines configured to convey light with a third wavelength are marked with dash-dotted line.

In the programmable logic part (PL) of each of the three embedded systems of the central computing unit, different logic fabrics may be arranged dedicated to each of the employed lights with different wavelengths (e.g. a first logic fabric for light with the first wavelength, a second logic fabric for light with the second wavelength, and a third logic fabric for light with the third wavelength). In some examples, each of the embedded systems of the central computing unit 103a is configured to receive processing results from the other embedded systems of the central computing unit.

Each embedded system of the central computing unit 103a (i.e. centrally arranged vertex) may communicate its processing results to the other embedded systems of the central computing unit. Consensus can be achieved about validity of a processing result if at least two of the embedded systems of the central computing unit generate the same processing result. Since signals are conveyed using light of different wavelengths, it can be easily determined where the is (likely) occurring. In case one of the embedded systems of the central computing unit has been diagnosed to generate faulty processing results, it can be shut down and/or ignored. In some examples, the embedded systems of the central computing unit are configured to perform a self-check (health check) and shut down if faulty processing results are output.

In some examples, the central computing unit further includes a central validator 115 to validate the processing results of each of the embedded systems of the central processing unit 103a. This is the case in the exemplary embodiment shown in FIG. 18. All the embedded computational systems of the central computing unit 103a have a two-way communication line with the validator. The validator 115 and the plurality of embedded systems 105a, 105b, 105c of the central computing unit may be arranged in a triple modular redundancy arrangement. It is also possible to use more than three embedded systems in the central computing unit (e.g. more than 4). Optionally, the total number of embedded systems in the central computing unit is odd.

Instead of using a validator 115 as shown in FIG. 18, it is also possible that the embedded systems of the central computing unit perform a self-evaluation of its processing result by checking the processing results of the other embedded systems of the central computing unit, for example as shown in FIG. 17. A combination is also envisaged.

In some examples, light obtained by combining light with the first wavelength, light with the second wavelength and light with the third wavelength results in light having a predetermined colour. Advantageously, this allows to easily pinpoint faulty components in the network. The combined light may for instance be white light in case signals are conveyed using red, blue, and green light in the network. If the combined light does not have a predetermined colour (e.g. does not combine into the white colour where red+green+blue=white), then it may be concluded that one of the embedded systems in the network is faulty. Based on the obtained colour it is possible to identify which embedded system has caused the faulty results.

In some examples, the validator of the central computing unit is configured to determine a value indicative of the colour of combined light of the different wavelength lights used in the network for carrying signals.

Some vertices which are arranged around the central vertex in the wheel network may be configured in redundancy arrangement (e.g. triple modular redundancy). The critical vertices in the network may have a redundancy arrangement with a validator. Each vertex in the drawing (cf. circles) may correspond to an embedded computational system (e.g. computer) configured to concurrently process optical signals with different wavelengths (e.g. three different colours). The different optical signals may be processed within the embedded computational system and subsequently be guided to a validator of the embedded computational system. In the programmable logic of the particular embedded computational system, the three optical signals can be concurrently processed through different dedicated logic fabrics (e.g. distinct logic fabrics for the three optical signals defined within the programmable logic part (PL) of a system-on-chip SoC or MPSoC). The outputted optical signals generated using the distinct logic fabrics may be guided to the validator (cf. embedded computational system with a triple modular redundancy arrangement). Optionally, a validator is arranged at every embedded computational system. In some examples, a validator can be used only for critical vertices in the network identified by performing a failure mode analysis. In this way, the cost related to the network architecture may be effectively reduced.

Each embedded computational system may include a programmable logic part (PL). In the programmable logic part (PL), three synchronous concurrent processes may be executed independently using the different optical signals (cf. light with different wavelengths can be used independently to obtain processing results). The programmable logic part of the embedded computational systems may run concurrently on distinct logic fabrics that are associated with at least three different wavelengths (e.g. different colors). The output generated by the programmable logic part may be transmitted to an optional validator (cf. redundancy arrangement, e.g. triple modular redundancy).

The optical signals with different wavelengths outputted by an embedded computational system arranged around the central processing unit can be guided to a dedicated validator of the respective embedded computational system before it reaches the multiplexer. The central computing unit 103a in the wheel topology network may include at least three distinct embedded systems dedicated to receive the optical signals of dedicated wavelengths from the embedded systems configured around the central computing unit (cf. vertices in the ring around the central vertex).

In FIG. 18, the redundant wheel topology is also provided with a central computing unit 103a comprising at least three embedded systems. The central computing unit may comprise at least a first, a second and a third embedded system. The different embedded systems of the central computing unit may be in communication with each other. Optionally, the different embedded systems of the central computing unit may be in communication with a validator. The first embedded system is dedicated to process optical signals with a first wavelength transmitted from the plurality of embedded systems arranged around the central computing unit in the wheel topology. Similarly, the second embedded system is dedicated to process optical signals with a second wavelength transmitted from the plurality of embedded systems arranged around the central computing unit in the wheel topology; and the third embedded system is dedicated to process optical signals with a third wavelength transmitted from the plurality of embedded systems arranged around the central computing unit in the wheel topology. This advantageous network design allows to effectively make the core of the redundant wheel topology fault tolerant.

The cyber-physical system can remain operational even if one or more edges of the network topology are interrupted (e.g. cut). Even if two edges of an outer vertex around the central vertex are interrupted, said outer vertex can still communicate directly and/or indirectly with other vertices in the network. Each outer vertex arranged around the central vertex may have three communication lines, namely two lines for communicating with neighbouring vertices in the ring (circle around the central vertex), and one line for communicating with the central vertex. This allows the vertices to remain directly/indirectly connected with the other vertices in the wheel network even if one or more failures occur in vertices or edges. The vertices in the wheel network may have a double point failure robustness (i.e. the vehicle may continue to operate at double point failure).

In the above example, three different electromagnetic wavelengths are used in the network (e.g. optical wavelengths corresponding to red, green and blue; e.g. non-visible optical light wavelengths, such as for instance 1550 nm, 1300 nm and 1600 nm), for example using laser diodes emitting light with different wavelengths. However, it is also possible to use a larger number of electromagnetic wavelengths, for instance five different wavelengths. Preferably, an odd number of different electromagnetic/optical wavelengths are employed. The optical signal obtained by combining the lights with different wavelengths may correspond to a preselected reference colour (e.g. combined light may be white light where red+green+blue=white).

The central vertex of the wheel network may include at least three sub-vertices. In some examples, each vertex/sub-vertex is an embedded computational system (e.g. SoC or MPSoC).

In some examples, the multiplexers used in the network are wavelength division multiplexers (WDM).

The operational reliability of the cyber-physical system can be significantly enhanced by using electromagnetic signals having different wavelengths.

In some examples, the network includes a plurality of multiplexers arranged at at least a subset of the embedded computational systems arranged in redundancy arrangement, wherein validators of the subset of the embedded computational systems are arranged at or integrated with the multiplexers. It is advantageous to place the validator at or integrated with the multiplexer.

Optionally, the validators are integrated within the multiplexers of the embedded systems. Advantageously, the validator can be built into the multiplexer to determine whether the at least three optical/electromagnetic signals with different wavelengths are consistent. In case the validator does not detect any inconsistency, the three signals may be passed through using multiplexing. If one of the three optical/electromagnetic signals is faulty, the multiplexer may only transmit the remaining consistent optical/electromagnetic signals. The faulty optical/electromagnetic signal may be filtered out.

It will be appreciated that the edges in the network may be at least one of a fibre-optic cables, conducting wires (e.g. copper wiring) or wireless communication lines.

It will be appreciated that instead of using multiplexer and de-multiplexers, the communication lines may be provided with a plurality of different waveguides configured to concurrently convey electromagnetic light (e.g. light) having different wavelengths. Each waveguide may be configured to carry light of a particular wavelength. In some examples, the fibre-optic cables may be configured to include at least over a part of its length at least a first, a second, and a third waveguide configured to convey light with a first wavelength, light with a second wavelength, and light with a third wavelength, respectively, wherein the first, second and third wavelengths are different.

It will be appreciated that the light with the first wavelength may correspond to light with a first visible color (e.g. red light), wherein the light with the second wavelength may correspond to light with a second visible color (e.g. green light), and wherein the light with the third wavelength may correspond to light with a third visible color, (e.g. blue light). In some examples, the first wavelength is in a range of 620 to 750 nm, the second wavelength is in a range of 495-570 nm, and the third wavelength is in a range of 450-495 nm. It will be appreciated that other ranges are also envisaged.

It will be appreciated that the cyber-physical system according to the invention may be employed in various types of vehicles. For example, the vehicle may be a hybrid electric off-highway dump truck. The resulting dump truck may provide for improved availability for the haulage process in surface mining. The truck may solve haulage problems occurring in the surface mines and more specifically to optimize the key performance indicators, being at least the overall availability of the dump truck, the dump truck handling, the dump truck navigation, the energy management of the dump truck, the safety of the dump truck, the hybrid electric operation of the dump truck and the throughput of the dump truck.

It will be appreciated that the method may include computer implemented steps. All above mentioned steps can be computer implemented steps. Embodiments may comprise computer apparatus, wherein processes performed in computer apparatus. The invention also extends to computer programs, particularly computer programs on or in a carrier, adapted for putting the invention into practice. The program may be in the form of source or object code or in any other form suitable for use in the implementation of the processes according to the invention. The carrier may be any entity or device capable of carrying the program. For example, the carrier may comprise a storage medium, such as a ROM, for example a semiconductor ROM or hard disk. Further, the carrier may be a transmissible carrier such as an electrical or optical signal which may be conveyed via electrical or fibre-optic cable or by radio or other means, e.g. via the internet or cloud.

Some embodiments may be implemented, for example, using a machine or tangible computer-readable medium or article which may store an instruction or a set of instructions that, if executed by a machine, may cause the machine to perform a method and/or operations in accordance with the embodiments.

Various embodiments may be implemented using hardware elements, software elements, or a combination of both. Examples of hardware elements may include processors, microprocessors, circuits, application specific integrated circuits (ASIC), programmable logic devices (PLD), digital signal processors (DSP), field programmable gate array (FPGA), logic gates, registers, semiconductor device, microchips, chip sets, et cetera. Examples of software may include software components, programs, applications, computer programs, application programs, system programs, machine programs, operating system software, mobile apps, middleware, firmware, software modules, routines, subroutines, functions, computer implemented methods, procedures, software interfaces, application program interfaces (API), methods, instruction sets, computing code, computer code, et cetera.

Herein, the invention is described with reference to specific examples of embodiments of the invention. It will, however, be evident that various modifications, variations, alternatives, and changes may be made therein, without departing from the essence of the invention. For the purpose of clarity and a concise description features are described herein as part of the same or separate embodiments, however, alternative embodiments having combinations of all or some of the features described in these separate embodiments are also envisaged and understood to fall within the framework of the invention as outlined by the claims. The specifications, figures and examples are, accordingly, to be regarded in an illustrative sense rather than in a restrictive sense. The invention is intended to embrace all alternatives, modifications and variations which fall within the spirit and scope of the appended claims. Further, many of the elements that are described are functional entities that may be implemented as discrete or distributed components or in conjunction with other components, in any suitable combination and location.

In the claims, any reference signs placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to an advantage.

1. A cyber-physical system for a vehicle capable of autonomous or semi-autonomous moving, wherein the cyber-physical system comprises a network with a plurality of units distributed therein, wherein the plurality of units includes sensors, actuators and embedded systems, wherein the plurality of units are distributed in the network in a fault tolerant network topology.

2-7. (canceled)

8. The cyber-physical system according to claim 1, wherein the network includes a central vertex arranged at the center of the wheel, wherein the central vertex is a central computing unit comprising at least three embedded computational systems communicatively coupled with respect to each other.

9. The cyber-physical system according to claim 8, wherein the central computing unit comprises at least a first, second, and third embedded computation system, wherein the first embedded computational system of the central computing unit is configured to receive and process first electromagnetic signals with a first wavelength from the plurality of embedded systems of the wheel network which are arranged around the central computing unit, wherein the second embedded computational system of the central computing unit is configured to receive and process second electromagnetic signals with a second wavelength from the plurality of embedded systems of the wheel network which are around the central computing unit, and wherein the third embedded computational system of the central computing unit is configured to receive and process third electromagnetic signals with a third wavelength from the plurality of embedded systems of the wheel network which are around the central computing unit.

10. (canceled)

11. (canceled)

12. The cyber-physical system according to claim 8, wherein the central vertex comprises a central validator, wherein each of the embedded systems of the central computing unit is configured to transmit its processing results to the validator, wherein the validator is configured to check whether the at least three embedded system of the central computing unit generate the same processing results.

13. The cyber-physical system according to claim 8, wherein the network includes a plurality of multiplexers (e.g. wavelength division multiplexer WDM) arranged at at least a subset of the embedded computational systems arranged in redundancy arrangement, wherein validators of the subset of the embedded computational systems are arranged at or integrated with the multiplexers.

14. (canceled)

15. The cyber-physical system according to claim 8, wherein the vehicle is a moving wheeled vehicle, and wherein the redundant subsets are allocated to at least one of each wheel of the vehicle or each physical or virtual axle of the vehicle.

16. (canceled)

17. The cyber-physical system according to claim 15, wherein the secondary wheel topology arrangement is arranged at physical or virtual axles of the vehicle.

18. The cyber-physical system according to claim 1, wherein the vehicle includes at least two physical or virtual axles, wherein each of the at least two physical or virtual axles of the vehicle is provided with a distributed network comprising a subset of vertices configured in a redundancy arrangement, wherein each subset of vertices includes at least three vertices, wherein each vertex of a same subset of vertices is configured to produce an output indicative of a same event independently from other vertices of the same subset of vertices, and wherein each subset of vertices is communicatively coupled to a validator unit configured to monitor and compare the output of the vertices of the same subset of vertices in order to determine whether each of the outputs indicates occurrence of the same event, wherein the validator unit is configured to identify a failing vertex responsive to determining that the failing vertex does not indicate the occurrence of the same event as the outputs of the other vertices of the same subset of vertices that do indicate the occurrence of the same event, and wherein the cyber-physical system is configured to continue operation using the outputs of the other vertices of the same subset of vertices and without using the different output generated by the failing vertex of the same subset of vertices.

19. The cyber-physical system according to claim 1, wherein the distributed network of the cyber-physical system includes a first subset of vertices in redundancy arrangement and a second subset of vertices in redundancy arrangement, wherein the vertices of the first subset of vertices and the vertices of the second subset of vertices are dedicated to a first physical or virtual axle of the vehicle and a second physical or virtual axle of the vehicle, respectively, and wherein the vertices of the first subset of vertices are positioned at or adjacent to the first physical or virtual axle, and wherein the vertices of the second subset of vertices are positioned at or adjacent to the second physical or virtual axle.

20. The cyber-physical system according to claim 19, wherein the cyber-physical system includes a distributed network of at least one further subset of vertices in redundancy arrangement and dedicated to a further physical or virtual axle of the vehicle, wherein the vertices of the at least one further subset of vertices are positioned at or adjacent to the further physical or virtual axle of the vehicle.

21. (canceled)

22. The cyber-physical system according to claim 18, wherein each validator unit includes a voter-comparator integrated circuit coupled to the at least three vertices of the respective subset of vertices, the voter-comparator circuit configured to validate redundant data outputs of the at least three vertices in the respective subset of vertices, wherein the voter-comparator circuit is configured to determine an output result according to a majority of the plurality of redundant outputs of each of the at least three-vertices in the respective subset of vertices.

23. The cyber-physical system according to claim 22, wherein the voter-comparator integrated circuit is configured to detect a computation error or faulty output according to the plurality of redundant outputs generated by the at least three vertices in the respective subset of vertices.

24. The cyber-physical system according to claim 18, wherein the vertices (e.g. embedded systems) in redundancy arrangement execute a same application software in a separated and isolated memory segments and in one or more dedicated processors.

25. The cyber-physical system according to claim 18, wherein the vertices (e.g. embedded systems) in redundancy arrangement execute similar sets of instructions in separated logic fabrics of the programmable logic part of the embedded system.

26-45. (canceled)

46. A method of arranging a network of a cyber-physical system for a vehicle capable of autonomous or semi-autonomous moving, the method comprising the steps of:
receiving an initial network design with a plurality of interconnected distributed units, wherein the plurality of units includes sensors, actuators, and embedded systems (vertices);
performing a fault analysis to identify lower reliability items in the initial network design with a reliability lower than a threshold value,
arranging the lower reliability items in redundancy arrangements,
interconnecting the redundancy arrangements in a fault tolerant network topology.

47. (canceled)

48. (canceled)

49. A method for improving the key performance indicators of a cyber-physical system of a vehicle, the method comprising the steps of:
interpolate the nominal state vector of the cyber-physical system from pre-calculated states derived from the digital twin of the vehicle by parameter tuning of meteorological data, terrain data, safety data and vehicle dynamics data;
calculate the actual state vector of the cyber-physical system derived from the digital twin of the vehicle by measuring of meteorological data, terrain data, safety data and vehicle dynamics data;
compare the actual state vector and the nominal state vector of the cyber-physical system of the vehicle;
determine the corrective actions to let the actual state vector coincide with the nominal state vector of the cyber-physical system of the vehicle;
execute the proposed corrective actions;
verify the equality of the actual state vector and the nominal state vector of the cyber-physical system of the vehicle after the corrective actions.
